(19) United States
(12) Patent Application Publication
(10) Pub. No.: US 2014/0279192 A1
(43) Pub. Date: Sep. 18, 2014

(54) METHOD AND SYSTEM FOR PERSONALIZATION OF A PRODUCT OR SERVICE

(71) Applicant: JoAnna Selby, (US)

(72) Inventor: JoAnna Selby, Sherman Oaks, CA (US)

(21) Appl. No.: 13/827,017

(22) Filed: Mar. 14, 2013

(51) Int. Cl. G06Q 30/06

(52) U.S. Cl. CPC G06Q 30/0631
USPC 705/26.7

(57) ABSTRACT

The present disclosure relates to automated or computerized devices and methods for shopping.

### BACKGROUND OF THE DISCLOSURE

The present disclosure relates to personal and interior/exterior shopping, and more particularly, to automated or computerized personalization of a product or service to a consumer, retailer or service provider.

Our world has developed rapidly in the information age. Information of all sorts and in all conceivable areas is readily available to those having access to computer technology. Further, advances have been made in analyzing and categorizing physical traits and characteristics. Technology is also available to retain huge amounts of data on many areas of commerce.

There has been a relatively small amount of attention to automating shopping beyond displaying specific products and providing options to various products. There is in fact a need to better marry an individual's or entity's specific needs and desires to the choices available in the market. Moreover, there is a need to better characterize a consumer's needs and to link such needs to product choices. Such approaches will save the consumer time and effort as well as present to the consumer options that might never be identified through conventional methods. Moreover, where there is a better match between consumer wants and needs and the product or service, increased commercialization results.

The present disclosure addresses these and other needs.

### SUMMARY

Briefly and in general terms, the present disclosure is directed at automated devices and approaches to commercial activity. In one aspect, automated or computerized devices and methods for shopping are presented.

In one or more embodiments, a process executed by various systems on various devices to personalize the consumer's purchases of products and services, including one or more of receiving data of a consumer, retailer or service provider; receiving product or service data; receiving data to personalize a consumer to a product or service and/or associated retailer or service provider; receiving data to personalize a service provider or retailer and/or service or product to a consumer; utilizing data to determine the “It's you”/Match/Preference/physical characteristics that match by cross-referencing the characteristics of a space, consumer, product and/or service to the match/physical characteristics of a space, consumer, product and/or service; utilizing data, database, software, Automatic Identification and Data Capture (“AIDC”) and/or unique product identifier and/or imaging generator for a consumer, retailer or service provider to better assess or find a cross-referenced/correlating consumer, product, service or space; and associating data with an AIDC and/or unique product identifier, software and/or database along with a reader that interprets the data; retrieving data on characteristics such as age(s), height(s), style(s), occasion(s), color(s), pattern(s), shape(s), measurement(s), dimension(s), size(s) surface type(s)/material(s), additive(s) and/or weight(s) of a product/service/space/consumer. The system can also include an AIDC and/or unique product identifier, software, website and/or database which is able to communicate/transfer/relay the data on any device. Also included is a device that can retrieve data from an implanted AIDC and/or unique product identifier, software, website and/or database. Further, data can be stored and utilized in a consumer's, service provider's and retailer's personal profile.

It is contemplated that the present system and method will utilize technology including but not limited to a computer, personal digital assistant (PDA), cell phone or smartphone, app, laptop, desktop, a tablet, notebook, netbook, device with Android or iOS, media content player, television set including broadcast tuner, home system (like a video game station/system, but with relating to assisting a consumer), full-body scanner, full body product scanner (scans products instead of people), sixth sense technology wearable gesture interface or any electronic device capable of receiving imaging data. It can also be a display or output device such as television, monitor, projector, digital photo frame, display panel, printer, sixth sense technology wearable gesture interface, cash register or any other device having necessary features. The system and devices thereof are further contemplated to include a non-transmitting computer readable storage medium having stored thereon software including executable computer instructions to affect the personalization of commercial activity.

To create an image of the consumer/space/product/service, receiving devices can be provided with two or more cameras, two or more video cameras or scanners to create a 2D or 3D image with dimensional movement that will be able to infer the sizes, measurements, dimensions or shapes of a consumer/space/product/service. The device will do this by judging the distance between the camera/scanner/video camera locations on the device and then having a mechanism that will determine the speed of light to judge distance from consumer/space/product/service at various points to compute a 2D or 3D image of the consumer/space/product/service. If the consumer/space/product/service moves then the device will show the consumer/space/product/service in real time by constantly judging the speed of light from the consumer/space/product/service to the device.

In one particular embodiment, the consumer could enter a measurement of the consumer/space/product/service before or after taking a frontal image of the consumer/space/product/service to determine the other measurements of the consumer/space/product/service to form a 2D representation of the consumer/space/product/service. To determine a 3D representation of the consumer/space/product/service, the consumer could select 3D symmetrical (for instance a round table has 3D symmetry because it's width is equal to depth) or the consumer could take another image of the consumer/space/product/service on the opposite axis, so instead of a frontal image the consumer would take a side image to determine the consumer/space/product/service 3D asymmetrical image. Such technologies can be connected over wired or wireless data networks such as LAN, Internet, WiFi, Data (Like 3G or 4G) and will work with Android or iOS and PC or Mac. It is further contemplated that any AIDC and/or unique product identifier, database, software or associated website such as but not limited to an RSUTag, ProductCode, UCode, ServiceCode, SpaceCode, StyleCode, OccasionCode, ColorCode, PatternCode, ShapeCode, Dimension/MeasurementCode, Surface/MaterialCode, WeightCode could be able to communicate/transfer/relay/input the data on any device.

In further aspects, holographic imaging is contemplated. Thus, devices of the personalized system would be able to show a holographic image of product(s), service(s), consumer(s) or space(s) and a holographic image of a product(s)/service(s) on/in a consumer(s)/space(s). Codes such as UCode, SpaceCode, StyleCode, OccasionCode, ColorCode, PatternCode, ShapeCode, Dimension/MeasurementCode, Surface/Material/TextureCode, WeightCode, AdditiveCode, ProductCode, PurchaseStatsCode and/or ServiceCode can be relied upon to have the ability to be put into any device by either swiping a card or permanently be implanted to gather data consistently about the consumer's home/office/product/service or the consumer itself. Thus, in a particular aspect, the consumer can be able to enter/scan a ProductCode or ServiceCode at a cash register or a scanning/input device at a store/mall to view the consumer's various ServiceCode(s) or ProductCode(s). Device can have the option to Adjust/Change/Retake any image generation or dimensional measurement image previously evaluated, if image is evaluated to be a bad image by seeing if the pixels are not defined or by cross-referencing a good image with the current image to evaluate if the image is good or bad by the consumer and/or the device recognizing a bad or good image. The device will also either recognize the light spectrum of the space/consumer/product/service to derive accurate information on coloring. Moreover, the subject's device will utilize voice recognition and/or touch screen technology and will be able to differentiate between different characteristics via 3 Dimensional Recognition. In one particular aspect, the system will show the consumer, service provider or retailer a range for completeness if the consumer has the profile 20% complete or 90% complete. The system can further utilize GPS to help consumer's find retailer/service provider locations with product(s)/service(s) nearby the consumer is wanting to purchase and give consumer directions along with link the retailer's/service provider's inventory to consumer, so the consumer can tell if the product(s)/service(s) is available in the store or online prior to going to the store. The system can be located in any location of a retailer, service provider or consumer and be able to scan, transmit, swipe an AIDC and/or unique product identifier via non-contact or contact to see what coupons, events on matches and preferences or any product(s)/service(s) that are in the consumer's purchases stats as low inventory, wish list, etc. that are available at the retailer's business, store, mall or online or other location. The system can be configured to utilize face recognition and the same technology to recognize the body, facial features, hair and nails, and/or utilize skin texture analysis. To communicate from consumer to device, a device of the configured system will utilize voice recognition. Devices will further utilize touch screen technology or Kinect technology (to select things on a device without touching the device). It will also utilize Kinect technology to move around the consumer's actual body as a virtual consumer. Draping technology for overlaying products/services on consumer or consumer's space is also contemplated to be incorporated into the system.

GPS can be employed to find stores with product(s)/service(s) nearby the consumer and give the consumer directions along with a link to the service provider's/retailer's inventory to the consumer, so the consumer can tell if the product(s)/service(s) \is available in the store or online prior to going to the store. Devices and systems located in a business, store, mall or online of a retailer or service provider will be able to scan, transmit, swipe an AIDC and/or unique product identifier, recognize a product via image recognition of the brand attributes like company label, product label, company name, product name (if product), logo, etc. via non-contact or contact to see and utilize what prices, coupons, events on matches and preferences or any product(s)/service(s) that are in the consumer's purchases stats as low inventory, wish list, etc. that are available at the retailer's or service provider's business, store, mall, online or other location.

Any device of the system can cross-reference any other device or system for the most accurate and up-to-date information of characteristics. If a consumer has changed in weight and/or height, the device will be able to analyze the consumer's current and previous weight and height. If there's not a drastic difference, say of more than a 5% change, the device will adjust dimension measurements for the difference.

Other features and advantages of the present disclosure will become apparent from the following detailed description, taken in conjunction with the accompanying drawings, which illustrate, by way of example, the principles of the invention.

### BRIEF DESCRIPTION OF THE DRAWINGS

FIGS. 1A-1C are depictions of one approach to a personalization system;

FIGS. 2A-2C are depictions of approaches to image capturing systems for a personalization system;

FIG. 3 is a depiction of yet another approach to image capturing systems for a personalization system;

FIGS. 4A-4C are depictions of yet another approach to a personalization system;

FIG. 5 is a depiction of an approach relating to personalization of a space;

FIGS. 6A-6B are depictions of a personalization system including hologram technology;

FIG. 7 is a flow chart depicting a system employing organization strategies;

FIG. 8 is a depiction of a system employing find features;

FIG. 9 is a depiction of a system involving designs and decoration features;

FIGS. 10-13 are flow charts, depicting various approaches of implementing the personalization system; and

FIGS. 14-16 are exemplar color charts which are contemplated for use with the system.

### DETAILED DESCRIPTION OF THE PREFERRED EMBODIMENTS

The present disclosure is directed towards automated or computerized systems embodying devices and methods for shopping or conducting other commercial activity.

The following are definitions and examples, which provide background for the contemplated embodiments.

Consumer—the actual individual or animal that is being analyzed to determine data or an individual, retailer or service provider that purchases products and/or services.

Imaging Generator—These would include technologies like scanning, camera(s), laser(s), video camera, x-ray, hologram or any technology that is capable of generating an image in 1D, 2D, 3D in real time or in past or future time.

Space—the actual space that is being analyzed to determine data. The space includes the interior and exterior of a home/office. The space will include every product/service in a design and decorating shell of an actual home/office. The design shell will be the Interior/Exterior Design products and services. The decorating shell will be the Interior/Exterior Decorating products and services. The space will include rooms in the home or office.

Beauty Product(s)/Service(s)—These products/services are for the consumer. The characteristics of Beauty Product/Service are style(s), occasion(s), color(s), pattern(s), shape(s), measurement(s)/dimension(s), surface type(s)/material(s) that will be cross-referenced to the consumer's style(s), occasion(s), color(s), pattern(s), shape(s), measurement(s)/dimension(s), surface type(s)/material(s) and/or weight.

The types of Beauty Products include Make-Up, Nail, Hair, Body, Apparel/Clothing, Accessories and Shoes. Accessories include Make-up Accessories, Nail Accessories, Hair Accessories, Body Accessories, Apparel/Clothing Accessories and Shoes Accessories.

They types of Beauty Services include Make-Up—Like Makeover, Nails—like Pedicure and Manicure, Hair—Like Hair Cuts, Hair Coloring, Hair Styling, Brow wax, etc. Body—Tanning, Spa, Apparel/Clothing—Seamstress, personalized clothing, personalized shopper, stylist, etc.

Interior/Exterior Product(s)/Service(s)—These products/services are for the home, office or any other space.

The characteristics of Interior/Exterior Product/Service are style(s), occasion(s), color(s), pattern(s), shape(s), measurement(s)/dimension(s) and/or surface type(s)/material(s) that will be cross-referenced to the consumer's style(s), occasion(s), color(s), pattern(s), shape(s), measurement(s)/dimension(s), and/or surface type(s)/material(s) utilizing the characteristics of Interior/Exterior Designer/Decorator ShapeCode, StyleCode, SurfaceMaterialCode, OccassionCode, PatternCode, ColorCode, Dimension/MeasurementCode, AddressCode and Consumer's AgeCode and GenderCode.

The external material of the product will assist in determining the characteristics of the product/a service is utilizing a material.

Home/Office Stats (home styles of home/office) will correspond with Product Stats (product styles of home/office).

Interior/Exterior Design—The products of Interior/Exterior Design would include fixtures or products that are attached to the property such as a home or office.

These characteristics of design can be determined from the products/services listed in home and office. These characteristics will assist in choosing products/services via cross-referencing the space/consumer with interior/exterior designer/decorator products/services. Each material relates the material on all the materials utilized on products and all the materials utilized in services.

Examples of Exterior/Interior Decorator Products/Decorator Product Sections include furniture, rugs, mats, landscaping, planters, cushions, lighting, décor, water features, wall plaques, drapes, umbrellas, furniture covers, address/company sign, fabrics, fire pits, storage containers/cabinet/bookshelves, ottomans, shelving, etc., room dividers, art, outdoor kitchens, mattresses, mirrors, tableware, flatware, drinkware, serveware, table linens, placecard holders, pillows, pillow inserts, throws, curtain and curtain hardware, candles, candle holder, vases, pebbles/rocks, sconces, lamps, chandeliers, Baskets, Clock, Home/Office Accents, Bedding, Towels, shower curtain and rings, storage accessories, racks and any other décor.

Examples of Exterior/Interior Decorator Services include Interior Decorator, Exterior Decorator, Wedding Planner, Events Coordinator, etc.

Examples of Exterior/Interior Designer Products/Designer Product Sections include Siding, Roofing, Garage Door, Moldings, Windows, Doors, Cabinetry, Counters/Countertops/Tops, Flooring, Sinks, Baths, Toilets, Organizers, Mirror/Mirror Frames, Railings, Walls and Hardware.

Examples of Exterior/Interior Design Services/Design Service Sections include Contractor, Remodeling Services, Home Improvement Services, Architect Service, Craftsman, Interior Designer, Landscape Architect, Landscape Designer.

UAPP—Consumers utilize this personalized app on devices to assist consumers in purchasing Beauty Products and Services. For example, see FIGS. 4A-C and 9.

UCopy—UCopy is utilized to provide the consumer a printout/hardcopy, email, image or fax similar to a receipt with more information. Device will transfer data/preferences previously determined about the consumer/consumer's space along with all companies and purchases referenced and includes RSUTags, UCode, ProductCode, ServiceCodes, USpaceLookup, UOrganizer, USearch, UFind or AIDC and/or unique product identifier associated with purchase.

User's Online Website (User's Personal Profile) (UPP)—Consumers utilize this personalized website on devices to assist consumers in purchasing Beauty Products and Services.

UHome—This system will be utilized in a consumer's home. UHome will be able to measure the various parts of the body. When the UHome scans the consumer, the platform below the consumer will turn slowly to give the UHome a 360 degree image to align the pixels to create a 3D image. UHome is connected to transfer information to a device wireless or via a wire to other device(s). UCode or other AIDCs are in this device with a database of these AIDC's information to generate the consumer an image, communicate and scan. The platform will also weight the consumer.

URApp—Retailers use this personalized app on devices to assist consumers in purchasing Beauty Products (See FIGS. 4A-C and 9).

Retailer's Online Website (Retailer Personal Profile) (RPP)—Retailers use this personalized website on devices to assist consumers in purchasing Beauty Products

URStore—Retailers use this device in the location of the retailer's products to scan in the products.

UStore/USStore—This device is located in a retailer/service provider location like a mall, department store, individual store, drug store, etc. The reference to product In-Store can be a mall with many stores, a department store with many brands or/and a single retailer, etc. Note: UStore is capable of anything listed in FIG. 10. Certain of the product(s)/service(s) associated with UStore are mentioned in paragraphs above. The characteristics associated with these product(s)/services can be categorized individually, grouped, cross-referenced for better analysis of the consumer's space. Service Provider uses this device at the location of service provider's service to scan in service and products.

USApp—Service Providers use this personalized app on devices to assist consumers in purchasing Beauty Products and Services (See FIGS. 4A-C and 9).

USpace—All devices mentioned in devices (definition) will have the capability of the following: These devices will be stationary or mobile devices. These devices will be devices that input information and/or output information. This USpace will be for consumer, retailers and service providers. USpace would deal with Interior/Exterior Design & Interior/Exterior Decorating Products & Services (Products & Services for these are in definitions) industry would be personalized to the consumer's space.

For the industries of Interior/Exterior Design & Interior/Exterior Decorating the characteristics that will create consumer's space personalization are StyleCode, OccasionCode, ColorCode, ShapeCode, DimensionMeasurementCode, SurfaceMaterialCode, PatternCode, AgeCode, Address Code and GenderCode. These will be further narrowed down to “It's YOU”/Match for product(s) and/or service(s) Match Characteristics, Physical Characteristics and Preference Characteristics of the consumer's space. These product/service matches will further be narrowed down by ConsumerSpaceStatCode, which will be derived by products/services shopped for or by scanning or creating an image generation of the home or office (including rooms inside of home or office and exterior yard of home or office). These characteristics will be evaluated from consumer's space inputting data, social media sites, consumer profiling of space, scanning or inputting AIDC and/or unique product identifier, dimension measurement, image generation, algorithms associating input(s) from consumer's space, consumer's space's calendar and algorithms from data derived from image generation. These characteristics can be categorized individually, grouped, cross-referenced for better analysis of the consumer's space.

Service Provider's Online Website (Service Personal Profile) (SPP)—Service Providers use this personalized website on devices to assist consumers in purchasing Beauty Products and Services. USStore—Service Provider uses this device at the location of service provider's service to scan in service and products.

Further programming of the system facilitates associating data with an AIDC and/or unique product identifier, software, website and/or database along with a reader that interprets the data. The system can include a ConsumerStatsCode/ConsumerSpaceStatsCode, which is a type of database, software, associated internet website or AIDC and/or unique product identifier that stores the various categorized consumer stats/consumer space stats including all sections in ConsumerStats/ConsumerSpaceStats definition that can be stored in UCode/SpaceCode as each section becomes a characteristic that can be cross-referenced with other characteristics. These can be called stat characteristics that will incorporate all characteristics that can be physical, match or preference characteristics and purchase stats and associated purchasestatcode. These stat characteristics of physical match or preference characteristics can be categorized individually, grouped, cross-referenced for better analysis of the consumer/consumer's space.

In associating data, the system can also be configured to process: PurchaseStatsCode—A type of database, software, associated website or AIDC and/or unique product identifier that stores the various categorized purchase stats that can be stored in UCode, SpaceCode, ProductCode and/or ServiceCode.

SpaceStatsCode—A type of database, software, associated website or AIDC and/or unique product identifier that stores the various categorized space stats including all sections in Space Stats definition that can be stored in SpaceCode.

StyleCode—A type of database, software, associated website or AIDC and/or unique product identifier that stores the various categorized styles of a space or consumer or product/service for a home/office/consumer and any descriptors of a style needed to narrow down the style for categorization. This will be stored with the corresponding UCode, SpaceCode, ProductCode and/or ServiceCode in any device. These will also have preferred and non-preferred styles.

OccasionCode—A type of database, software, associated website or AIDC and/or unique product identifier that stores the various occasions categorizing a space or consumer or product/service for a home/office/consumer. Occasions can consist of holidays, seasons, events, lifestyle (i.e. working out) that could alter the product(s)/service(s) that a consumer chooses for the consumer's home/office or for the consumer's fashion and any descriptors of an occasion needed to narrow down the occasion for categorization. This will be stored with the corresponding UCode, SpaceCode, ProductCode and/or ServiceCode in any device. These will also have preferred and non-preferred occasions.

ColorCode—A type of database, software, associated website or AIDC and/or unique product identifier that stores the various categorized colors of a space or consumer or product/service for a home/office/consumer and any descriptors of a color such as undertones, etc. needed to narrow down the color for categorization. This will be stored with the corresponding UCode, SpaceCode, ProductCode and/or ServiceCode in any device. These will also have preferred and non-preferred colors.

ShapeCode—A type of database, software, associated website or AIDC and/or unique product identifier that stores the various categorized shapes categorizing a space or consumer or product/service for a home/office/consumer and any descriptors of a shape such as symmetry, etc. needed to narrow down the shape for categorization. This code will include the various shapes of the body, body parts, face and facial features that can be selected as a likes or a dislikes of being too short, long, thick or thin that will be stored in the consumer's UCode called ShapePreferences. This will be stored with the corresponding UCode, SpaceCode, ProductCode and/or ServiceCode in any device.

Dimension/MeasurementCode—A type of database, software, associated website or AIDC and/or unique product identifier that stores the various categorized measurements determining a dimensional shape or size OR any size or dimensional shape to determine measurements of a space or consumer or product/service for a home/office/consumer and any descriptors of a dimension/measurement/size needed to narrow down the dimensional/measurementcode for categorization. This will be stored with the corresponding UCode, SpaceCode, ProductCode and/or ServiceCode in any device.

SurfaceMaterialCode—A type of database, software, associated website or AIDC and/or unique product identifier that stores the various types of materials on a surface of a space or consumer or product/service for a home/office/consumer and any descriptors of a surface material such as texture, etc. needed to narrow down the surface material for categorization. This will be stored with the corresponding UCode, SpaceCode, ProductCode and/or ServiceCode in any device. These will also have preferred and non-preferred surfaces.

PatternCode—A type of database, software, associated website or AIDC and/or unique product identifier that stores the various pattern(s) categorizing a space or product/service for a home/office/consumer and any descriptors of a pattern such as texture, etc. needed to narrow down the pattern for categorization. This will be stored with the corresponding UCode, SpaceCode, ProductCode and/or ServiceCode in any device. These will also have preferred and non-preferred patterns.

WeightCode—A type of database, software, associated website or AIDC and/or unique product identifier that stores the consumer's weight past, present and future, which will show fluctuations in weight if relevant to create an algorithm to determine a change of Measurement/DimensionCode. This will be stored with the corresponding UCode, SpaceCode, ProductCode and/or ServiceCode in any device.

HeightCode—A type of database, software, associated website or AIDC and/or unique product identifier that stores the consumer's height past, present and future, which will show fluctuations in height, if relevant to create an algorithm to determine a change of Measurement/DimensionCode by utilizing the WeightCode as well. This will be stored with the corresponding UCode, SpaceCode, ProductCode and/or ServiceCode in any device. This can be useful in dimension measurement.

AgeCode—A type of database, software, associated website or AIDC and/or unique product identifier that stores the consumer's age past, present and future via the consumer's birthday, which will show changes in age by corresponding to the present date, if relevant to create an algorithm to determine a change of Measurement/DimensionCode and HeightCode. This will be stored with the corresponding UCode, SpaceCode, ProductCode and/or ServiceCode in any device. This can be useful in Age consumer profiling and determining dimensional measurement as a change in time.

GenderCode—A type of database, software, associated website or AIDC and/or unique product identifier that stores the consumer's gender, which will show difference of males and females in preferences and characteristics, if relevant to create an algorithm to determine the product(s) and/service(s) a consumer should buy based on the consumer's gender. Can be cross-referenced. If GenderCode is cross-referenced with AgeCode the products and or services a 1 year old boy would be interested in are vastly different than a 50 year old woman. This will be stored with the corresponding UCode, SpaceCode, ProductCode and/or ServiceCode in any device. This can be useful in Gender consumer profiling.

AdditiveCode—A type of database, software, associated website or AIDC and/or unique product identifier that stores the various additives categorizing a space or consumer or product/service for a home/office/consumer and any descriptors of an additive needed to narrow down the additive for categorization. For ServiceCode of certain consumer beauty services, additives will be the same as ingredients and will be ranked from 0-100% based on safety and health (whether they contain toxic, natural or organic chemicals). This will be stored with the corresponding UCode, SpaceCode, ProductCode and/or ServiceCode in any device. These will also have preferred and non-preferred additives.

RSUTag—This can be a universal database, software, associated website or AIDC and/or unique product identifier cross-referencing consumer profiling categorizing products and services. Consumer Sector is anything pertaining to the consumer. Company sector is anything pertaining to the company. If categorized in the company sector, the RSUTag will be further narrowed down in the SIC (Standard Identification Classification) by Code and Industry or another classification for industry. If categorized in the consumer sector, the industries of the consumer's profile in consumer profiling would be part of the consumer's consumer sector. Consumer sector can be defined as industries that relate to a particular consumer that would be identified/generated by consumer profiling such as input data from or cross-referenced with an AIDC AND/OR UNIQUE PRODUCT IDENTIFIER, databases and/or consumer profiling. The company subsector would be further narrowed down into retailers and/or service providers in each industry based on the company SIC. The consumer subsector would be the retailers and/or service providers in each industry based on the industries in SIC that relate to the consumer's consumer profiling and any information obtained by an database, software, associated internet website or AIDC and/or unique product identifier or cross-referenced with an database, software, associated internet website or AIDC and/or unique product identifier and consumer profiling. The company sub-subsector would include the company and everything relating to the company utilizing all input data from database, software, associated internet website or AIDC and/or unique product identifier and consumer profiling such as ranking a company or cross-referenced with an database, software, associated internet website or AIDC and/or unique product identifier and consumer profiling. The consumer sub-subsector would include consumer and everything relating to the consumer utilizing all information generated/identified by consumer profiling techniques and input data from AIDC and/or unique product identifier or cross-referenced with an AIDC and/or unique product identifier and consumer profiling. The company sub-sub-subsector would include all products and/or services and anything relating to products and/or services identified by consumer profiling (such as ranking a product and/or service) and input data from AIDC and/or unique product identifier/databases or cross-referenced with an AIDC and/or unique product identifier/database and consumer profiling. The consumer sub-sub-subsector would deal with consumer products and/or services and everything relating to the consumer products and/or services generated by consumer profiling and/or data from AIDC and/or unique product identifiers/database or cross-referenced with an AIDC and/or unique product identifier/database and consumer profiling. This would be put into a database of RSUTags. These RSUTags would be able to generate information in 1D (one dimension), 2D and 3D. The RSUTags will be kept consistent via a cross-referencing algorithm to increase accuracy anytime any characteristic is cross-referenced or AIDC and/or unique product identifier/database is cross-referenced with consumer profiling. Let's use the example in the apparel industry of for a shirt that a consumer has an idea of categories such as style, occasion, color, shape, size, and material. Now the retailer will reference the shirt as having a certain or certain style(s), occasion(s), color(s), shape(s), size(s) and/or material(s) as well. These will be cross-referenced via the cross-referencing algorithm to get an accurate depiction of what the consumer ultimately is looking for as an end product.

It is contemplated that there should be an RSUReader to read/scan/communicate/relay/transfer data from the RSUTag into a processor of a device.

ProductCode. This ProductCode will be for any product in the SIC (Standard Industrial Classification). This will be a database, software, associated internet website or AIDC and/or unique product identifier (including but not limited to could be utilized as bar codes, Radio Frequency Identification (RFID), biometrics, magnetic stripes, Optical Character Recognition (OCR), smart cards, voice recognition, barcodes, RFID, bokodes that's 1D, 2D, 3D) or software for product data. This will show 1D, 2D and/or 3D product characteristics (product characteristics will include product style(s), occasion(s), coloring(s), shape(s), measurement(s), dimension(s), size(s), surface material(s), surface texture(s), additive(s) and pattern(s) for industries dealing with Interior/Exterior product(s), Make-Up product(s), Nail product(s), Hair product(s), Body product(s), Apparel/Clothing product(s) or Accessory product(s)), generated from the image generators (scanning, camera devices) and other software/databases/AIDCs and/or unique product identifiers or other data gathered. The data determined via the software/databases/AIDCs and/or unique product identifiers and imaging generators will be stored in the productcode called product data. The product style and occasions will be determined by consumer profiling or retailer input that relates what style the consumer associates with the product and what occasion the consumer associates the product to be stored in ProductCode for consumer or other similar consumer's future use, if relevant. The productcode will keep track of product inventory to be able to notify consumer, if product is in store. The productcode will have the current price, coupons and advertisements of products. The productcode will be organized by type of product categorized by the SIC (Standard Industrial Classification) or a different classification system called product type. The productcode will be able to generate data in 1D, 2D, 3D. Customer satisfaction will be rated as a combination of functionality, durability, quality and affordability or overall customer satisfaction. These codes will be ranked depending on how the consumers that purchased the product ranks the product from 0-100% in customer satisfaction, which will be stored in the productcode as product ranking and related to UCode or SpaceCode, if relating to a beauty or interior/exterior product, respectively. The consumer(s) that purchased the product will be able to rank the product with a 0-100% in customer satisfaction called product ranking, which will be assigned ProductCode. The product ranking(s) under the same company that have the same product type will be combined and that will receive a 0-100% average of all the products that fall within the same product type, which will be called a product type ranking, which will be assigned a ProductCode with the ranking. Then the overall company will be ranked by an average of the product type ranking(s) called the product company ranking, which will also receive a productcode. If the company has a ServiceCode, the Servicecode service provider ranking and the ProductCode product company ranking will be averaged out based on the amount of transactions done with services or products to come up with a ranking from 0-100% called product/service ranking. ProductCode will utilize cross-referencing get the most accurate data.

A product could have more than one product type (some products have more than one utility) or product company (some products are sold at various companies). The same as a product company could have more than one product type (sells many types of products at one company) or more than one product (more than one product sold at a company).

ProductCode can have an associated StyleCode, OccasionCode, ColorCode, ShapeCode, Dimension/MeasurementCode, SurfaceMaterialCode, PatternCode WeightCode and AdditiveCode, if the industry is dealing with beauty product(s).

ProductCode can also have an associated StyleCode, OccasionCode, ColorCode, ShapeCode, Dimension/MeasurementCode, SurfaceMaterialCode, PatternCode, AgeCode, GenderCode, AddressCode if the industry is dealing with interior/exterior design or decorating product(s).

In this regard, it is contemplated that there would be a ProductReader to read/scan/communicate/relay/transfer data from the ProductCode or associated AIDC and/or unique product identifier, database, software, website into device. These devices can also be put outside of malls or stores/businesses to be cross-referenced with a UCode or associated consumer AIDC and/or unique product identifier, database, software, website to see if an product relates to the consumer's criteria.

ServiceCode. This ServiceCode or associated AIDC and/or unique product identifier, database, software, website will be for any service in the SIC. This will be an associated service AIDC and/or unique product identifier, database, software, internet website or AIDC and/or unique product identifier (including but not limited to could be utilized as bar codes, Radio Frequency Identification (RFID), biometrics, magnetic stripes, Optical Character Recognition (OCR), smart cards, voice recognition, barcodes, RFID, bokodes that's 1D, 2D, 3D) for service data. The servicecode will gain information from other AIDC and/or unique product identifiers relating to the service called service data. This will show 1D, 2D, 3D service characteristics (service characteristics will include service of products in style, occasion, coloring, shape, measurements, dimensions, size, surface material, surface texture, additives and/or pattern for industries dealing with Interior/Exterior product(s), Make-Up product(s), Nail product(s), Hair product(s), Body product(s), Apparel/Clothing product(s) or Accessory product(s)) generated from the image generators (scanning, camera devices) or scanning AIDC and/or unique product identifiers such as the product(s)'s ProductCode(s) utilized in the service to show with an imaging generator the 1D, 2D or 3D image of the actual service through different parts of completion with the product(s) referenced on the image utilized for future reference to be saved to the ServiceCode relating to the UCode or SpaceCode. The servicecode will be able to generate data in 1D, 2D, 3D. The servicecode will be organized by type of service categorized by the SIC (Standard Industrial Classification) or a different classification system called service type. Customer satisfaction will be rated as a combination of reliability, responsiveness, assurance, empathy, and tangibles from 0-100% or can rank as overall customer satisfaction 0-100%. These codes or software categorization will be ranked depending on how the consumers that purchased the service ranks the service provider individual to determine the service provider/company, service type within the service provider/company, and service provider individuals from 0-100% in customer satisfaction. The consumer will rank the service provider individual and select service type along with service provider/company on an online portal or rank and select the service provider individual's ServiceCode and confirm service type and service provider/company. The Service type might be hair or nails, etc. of a service provider/company. The Service Provider Individual is the individual worker that works under a service type(s) and further under a service provider(s)/company(s). The consumer(s) that purchased the service will be able to rank the service provider individual with a 0-100% in customer satisfaction called overall service provider individual customer satisfaction after many consumers rank the service provider individual. The overall service provider individual will be associated with that service provider ServiceCode. The service provider individuals under the same company that have the same service type will be combined and that will receive a 0-100% average of all the services that fall within the same service type, which will be called a service type ranking and will receive a ServiceCode. Then the overall company will be ranked by an average of the overall service type 0-100% called the service provider ranking, which will be given a ServiceCode as well. If the company has a ProductCode as well, the ProductCode ranking associated with the product company ranking and the ServiceCode ranking associated with service provider ranking will be averaged out based on the amount of transactions done with services or products to come up with a ranking from 0-100% called product/service ranking ServiceCode will utilize cross-referencing get the most accurate data. A service provider individual could have more than one service type (a hair stylist might do hair coloring as well) or service provider (from either past employers or more than one job). The same as a service provider could have more than one service type (more than one service type at a service provider) or more than one service provider individual (more than one worker at the service provider).

The system could then include a ServiceReader to read/scan/communicate/relay/transfer data from the ServiceCode or associated AIDC and/or unique product identifier, database, software, website into device. These devices can also be put outside of malls or stores/businesses to be cross-referenced with a UCode or associated consumer AIDC and/or unique product identifier, database, software, website scanned in to see if a service relates to the consumer's criteria.

UCode—This UCode can be data of any consumer purchasing services/products in the SIC. This will gather information via image generation, consumer profiling and consumer input that generates associated AIDC and/or unique product identifier, database, software, website called UCode. AN AIDC and/or unique product identifier including but not limited to could be utilized as bar codes, Radio Frequency Identification (RFID), biometrics, magnetic stripes, Optical Character Recognition (OCR), smart cards, voice recognition, barcodes, RFID, bokodes, smart cards that's 1D, 2D or 3D consumer stats (See Definition) (consumer stats will include all stats gathered about the consumer(s)/consumer via UApp, UPP, UHome and UStore or any other device to store in a called UCode. Anything generated from any device any consumer profiling/AIDC and/or unique product identifier technology/device or any other data input) This will show 1D, 2D and/or 3D characteristics (consumer stats will include consumer StyleCode, OccasionCode, ColorCode, ShapeCode, Dimension/MeasurementCode, SurfaceMaterialCode, WeightCode and AdditiveCode, if associated with the industries of Beauty product(s)/service(s) or consumer. These StyleCode, OccasionCode, ColorCode, ShapeCode, Dimension/MeasurementCode, SurfaceMaterialCode, WeightCode and AdditiveCode) will be determined through image generation from the scanning/camera devices or other AIDCs and/or unique product identifiers or any other data input by consumer or from a device. The UCode can also gain data and images from other AIDC and/or unique product identifier, such as ServiceCode(s), ProductCode(s), SpaceCode(s), etc. relating to the consumer called consumer data. The UCode can be able to generate data in 1D, 2D, 3D.

This can be a type of AIDC and/or unique product identifier that's 1D, 2D or 3D for consumer stats. This can show 1D, 2D, and/or 3D consumer stats (consumer stats will include all stats gathered about the consumer via UApp, UPP, UHome and UStore or any consumer profiling/AIDC and/or unique product identifier or any other data input by consumer or from a device.) For example, UApp has stats on the consumer's coloring, shape, measurements, etc. relating to the industry of Clothing, Shoes, Accessories, Makeup, etc. The UCode can only take the most accurate stats. Considering the possibility that UApp stats are as accurate as UPP stats, these would be taken interchangeably to be compared for the best stat for the consumer. If UHome stats are more accurate than UApp and UPP, so if consumer has UHome stats these would be utilized in UCode. If UStore stats will be more accurate than UApp, UPP and UHome, so UStore stats will be utilized in UCode. If an consumer profiling/AIDC and/or unique product identifier/image generator that has stats that are more accurate than the UApp, UHome, UStore, UPP, then these stats will be utilized. Obviously the most accurate stats will depend on the heightened technology of the software and/or hardware.

This technology also enables the profiling of individual consumers. In addition, retail chain membership cards (issued mostly by drug or grocery stores and specialty “big box” retail stores such as sporting equipment, office supply, or pet stores) use bar codes or other AIDC and/or unique product identifier to uniquely identify consumers, allowing for customized marketing and greater understanding of individual consumer shopping patterns. At the point of sale, shoppers can get product discounts or special marketing offers through the address, e-mail address, etc. provided at registration.

The UCode can also incorporate anything searched by the consumer through a tagging algorithm similar to an RSSFeed platform within the UApp, UPP, UHome and UStore or any device. The UCode can recognize what the subject is searching and store the data for future use and understanding of the user.

The UCode will also incorporate information generated by the cloud storage and cloud computing. The consumer will become the business. This will also keep track of stats of inventory of products and/or services the consumer has purchased to not only create profiling, but notify the consumer when to purchase another product/service that's similar or the same based on the consumer purchase stats and previous ServiceCode(s) or ProductCode(s) associated with the consumer's UCode. For example a type of consumer purchase stat would be when the consumer will purchase the same product/service again based on the time frame of previous purchases within the same product/service . . . essentially running inventory like the consumer was a business. Purchase stats will relate to the consumer's purchase history per service or product via the UCode's associated ServiceCode or ProductCode, respectively. Purchase history will relate to if the consumer's patterns show the consumer purchase frequency product/service type. The UCode will connect with the productcodes or servicecodes and search the type of product or service to find a product or service similar via purchase stats or will look up the exact previous product/service based on consumer preference. The UCode will provide information of the product/service from a previous purchase or a new product or service including: company of product/service, product name or service provider individual name, contact information including email, website, address, phone number and fax of company that product/service was purchased or will be purchased.

Since the consumer ranks a product/service provider individual the consumer's personal ranking will be a part of the consumer's UCode. This will create a personalized consumer ranking for product/service ranking, the product company ranking, service provider ranking, product type ranking, service type ranking and product ranking and service provider individual ranking. These codes will be rated depending on how the consumer rates the company: product/service ranking, the product company ranking, service provider ranking, product or service type and product or service provider individual from 0-100% in customer satisfaction, which is further explained in ServiceCode and ProductCode. Data can also be generated by any technology that relates a ranking of a consumer for a product/service provider individual.

Product/Service Criteria will be utilized/stored in UCode. Devices (See Definitions) and/or UApp, UHome, UPP and UStore will be able to search based on the consumer's UCode of previously purchased product/service criteria to compare/cross-reference with current product/service criteria of many products/services to find competitors for the consumer. If consumer is currently at the location of purchase or wants to go to the store for purchase it will search nearby locations via GPS by cross-referencing product/service criteria to compare with product/service criteria the consumer is interested in purchasing. Repeatedly purchased types of product(s)/service(s) will be asked if client would like to add to their favorite retailers and service providers. This technology will also be able to notify the consumer, if they need to purchase something in the store they are visiting based on consumer's purchase history. Let's say a consumer is planning on going grocery shopping. This device will know what the consumer would likely be out of at home based on the purchase history to create inventory. The consumer can go through the list and select what the consumer needs at that store, online, in a mall, drug store, department store, boutique, etc. via the GPS on how far the consumer is willing to travel for the product or service. Based on the consumer history of shopping at repetitive retailers/service providers with times of shopping and locations . . . this technology will ask if client would like to add this to the consumer calendar on a weekly, daily, monthly basis at a certain time depending on the consumer's history of purchasing pattern.

UReader. The system would then further include an UReader to read/scan/communicate/relay/transfer data from the UCode or associated AIDC and/or unique product identifier, database, software, website into a device.

There should be a ServiceReader to read/scan/communicate/relay/transfer data from the UReader or associated AIDC and/or unique product identifier, database, software, website into device.

SpaceCode. This SpaceCode will be for any space that a consumer would like to purchase a product(s) and/or service(s) in the SIC. This in particular is discussing Interior/Exterior Products/Services for home and office. This will be an associated AIDC and/or unique product identifier, database, software, website gathering information via image generation, consumer profiling and consumer input that generates a software or AIDC and/or unique product identifier called SpaceCode. If an AIDC and/or unique product identifier it will be including but not limited to could be utilized as bar codes, Radio Frequency Identification (RFID), biometrics, magnetic stripes, Optical Character Recognition (OCR), smart cards, voice recognition, barcodes, RFID, bokodes, smart cards that's 1D, 2D, 3D consumer's Space Stats (See Definition) (consumer's space stats will include all stats gathered from the space via any device, UApp, UPP, UHome and UStore, if the SpaceCode is relating to the industry of services and/or retailers of Interior/Exterior products/services for home and office.) This will show 1D, 2D, 3D of consumer space characteristics (consumer space characteristics will include the space's StyleCode, OccasionCode, ColorCode, ShapeCode, Dimension/MeasurementCode, SurfaceMaterialCode, PatternCode, if associated with the industries of Interior/Exterior product(s)/service(s) for a home or office. These style(s), occasion(s), color(s), shape(s), measurement(s), dimensions(s), surface material type(s), surface texture type(s) and/or pattern(s) will be determined through image generation (check definition), other AIDC and/or unique product identifiers (of products/services in the space like related ProductCode, ServiceCode, USearch, UPCs, etc.), consumer profiling and company's input on product/service to generate the software or AIDC and/or unique product identifier SpaceCode). The SpaceCode will also gain information from other AIDC and/or unique product identifiers relating to the consumer's space called consumer's space data. The SpaceCode will be able to generate data in 1D, 2D, 3D with or without dimension movement (See Definition).

In an alternative approach, there is also contemplated a type of AIDC and/or unique product identifier, database, software, website that's 1D, 2D or 3D for consumer's space stats. This will show 1D, 2D, and/or 3D of consumer space stats (space stats will include all stats gathered about the consumer via UApp, UPP, UHome and UStore or any other device or consumer profiling/AIDC and/or unique product identifier.) For example, UApp has stats on the consumer space's coloring, shape, measurements, etc. relating to the industry of Interior and/Exterior of a home/office. The SpaceCode will only take the most accurate stats. Considering the possibility that UApp stats are as accurate as UPP stats, these would be taken interchangeably to be compared for the best stat for the consumer's space. If UHome stats are more accurate than UApp and UPP, so if consumer has UHome stats these would be utilized in SpaceCode. If UStore stats will be more accurate than UApp, UPP and UHome, so UStore stats will be utilized in SpaceCode. If an consumer profiling/AIDC and/or unique product identifier/image generator that has stats that are more accurate or available than the UApp, UHome, UStore, UPP, then these stats will be utilized. The most accurate stats will probably depend on the heightened technology of the software and/or hardware.

This technology also enables the profiling of individual consumers and what the consumer purchases for the consumer's space. In addition, retail chain membership cards (issued mostly by grocery stores, drug stores, department stores, the “everything” store like Walmart, specialty, “big box” retail stores such as sporting equipment, office supply, or pet stores) use bar codes or other AIDC and/or unique product identifier to uniquely identify consumer's space, allowing for customized marketing and greater understanding of individual consumer space's shopping patterns. At the point of sale, shoppers can get product discounts or special marketing offers through the address, e-mail address, etc. provided at registration.

The SpaceCode will also incorporate anything searched by the consumer through a tagging algorithm similar to an RSSFeed platform within the UApp, UPP, UHome and UStore. The SpaceCode will recognize what the consumer is searching for the consumer's space and store the data for future use and understanding of the consumer's space.

The SpaceCode will also incorporate information generated by the cloud storage and cloud computing.

This will also keep track of stats of inventory of products and/or services the consumer has purchased for the space to not only create profiling, but notify the consumer when to purchase another product/service for the space that's similar or the same based on the consumer's space purchase stats and previous ServiceCode(s) or ProductCode(s) associated with the consumer's SpaceCode. For example a type of consumer's space purchase stat would be when the consumer will purchase the same product/service again based on the time frame of previous purchases within the same product/service . . . essentially running inventory like the consumer's space is a business, but since consumers are individuals working in businesses it will help businesses as well. Purchase stats will relate to the consumer's purchase history per service or product for the consumer's space via the SpaceCode's associated ServiceCode or ProductCode, respectively. Purchase history will relate to if the consumer's patterns show the consumer's space purchase frequency product/service type (reference from ProductCode and ServiceCode). The SpaceCode will connect with the productcodes and servicecodes and search the type of product or service to find a product or service similar via purchase stats or will look up the exact previous product/service based on what the consumer prefers. The SpaceCode will provide information of the product/service from a previous purchase or a new product or service including: company of product/service, product or service provider individual name, contact information including email, website, address, phone number and fax of product/service, contact information including email, website, address, phone number and fax of company that product/service was purchased or will be purchased.

Since the consumer ranks a product/service provider individual the consumer's personal ranking of the space will be a part of the consumer's SpaceCode. This will create a personalized consumer space's ranking for product/service ranking, the product company ranking, service provider ranking, product type ranking, service type ranking and product ranking and service provider individual ranking. These codes will be rated depending on how the consumer rates the company in regards to the consumer's space: product/service ranking, the product company ranking, service provider ranking, product or service type and product or service provider individual from 0-100% in customer satisfaction, which is further explained in ServiceCode and ProductCode. Data can also be generated by any technology that relates a ranking of a consumer's space for a product/service provider individual.

Product/Service Criteria Space—Data in a SpaceCode of products/services (Product and service company, product company, service provider, product type, service type, product and service provider individual) including Product/Service purchasing (particular product/service in the wish list, low inventory, wanted for purchase, previously purchased product/service in inventory), Rankings (Product/service ranking, the product company ranking, service provider ranking, product type ranking, service type ranking and product ranking and service provider individual ranking), price (with/without coupons), If interior/exterior product/service then criteria will include: styleCode, OccasionCode, ColorCode, ShapeCode, Dimension/MeasurementCode, patterncode and surfacematerialcode (AddressCode, AgeCode and GenderCode of consumer.)

Devices and/or UApp, UHome, UPP and UStore will be able to search based on the consumer's SpaceCode for current price of product/service criteria space to compare/cross-reference with current product/service criteria space of many products/services to find competitors for the consumer's space. If consumer is currently at the location of purchase or wants to go to the store for purchase, SpaceCode will be able to search nearby locations via GPS by cross-referencing product/service criteria space to compare with product/service criteria space the consumer is interested in purchasing. Repeatedly purchased types of product(s)/service(s) will be asked if consumer would like to add to their favorite retailers and service providers. This technology will also be able to notify the consumer, if they need to purchase something in the store they are visiting based on consumer's purchase history. Let's say a consumer is planning on going grocery shopping. This device will know what the consumer would likely be out of at home based on the purchase history to create inventory. The consumer can go through the list and select what the consumer needs at that store, online, in a mall, in a department store via the GPS on how far the consumer is willing to travel for the product or service. Based on the consumer history of shopping at repetitive retailers/service providers with times of shopping and locations, this technology will ask if client would like to add this to the consumer calendar on a weekly, daily, monthly basis at a certain time depending on the consumer's history of purchasing pattern.

Utilizing UCode and ProductCode and ServiceCode and SpaceCode and RSUTag fast-selling items can be identified quickly and automatically reordered. Slow-selling items can be identified, preventing inventory build-up. The effects of merchandising changes can be monitored, allowing fast-moving, more profitable items to occupy the best space. Historical data can be used to predict seasonal fluctuations very accurately. Items may be repriced on the shelf to reflect both sale prices and price increases. Product/ServiceCode can be compared to UCode to see if the product/service matches with consumer. Gift Cards registered to either a UCode, ProductCode, ServiceCode, RSUTag depends on what you need. RSUTag will incorporate data from UCode, ProductCode, SpaceCode, ServiceCode as well as other AIDCs and/or unique product identifiers. RSUTag, UCode, ProductCode, ServiceCode and SpaceCode will have information regarding previous purchases/services used, current purchases/services being used and will be able to generate future purchases/services. UCode will be able to cross-reference ProductCode for the consumer to see if the product is a Match. UCode will be able to cross-reference ServiceCode for the consumer to see if the service is a Match.

In one particular embodiment, the present disclosure is directed towards a system and a process executed by various systems on various devices to personalize the consumer's purchases of products and services, where the system and devices can include a computer readable storage medium having stored thereon software including executable computer instructions to effect the personalization of commercial or other activity. The approach can involve receiving data of a space, consumer, retailer or service provider or data of associated a product or service. Company location(s) versus consumer location(s) (map to show if the company locations are easily accessible to consumer) can be identified. Product/service sales with consumers are also determined such as given as a total amount for each product/service after searching through section to subsection to sub-subsection to determine what products/services are selling or not selling. Moreover, rankings by consumer's device/technology can be organized monthly for example Month of January—200 new rankings with a ranking percentage of 80% on Customer Satisfaction. Given in charts, graphs and descriptions.

Further, information gathered from consumer(s) can be employed to derive from a number of resources to build comprehensive profiles on consumers in order to sell product(s)/service(s). Space Stats can be derived by consumer profiling of consumer. Since consumer stats can change over time, the consumer stats will be graphed with past, present and future information. This graphing will help to determine how to sell product(s)/service(s) based on the information gathered from past, present and future information to be cross-referenced via cross-referencing to other consumers that have similar information to determine the other consumer's past, present and future stats.

Information can also be gathered from a consumer's space about the consumer to derive from a number of resources to build comprehensive profiles on consumer's space in order to sell product(s)/service(s) to consumer(s). Space stats can be derived by consumer profiling of consumer or consumer's space. Since a consumer's space stats can change overtime, the consumer's space stats will be graphed with past, present and future information. This graphing will help to determine how to sell product(s)/service(s) based on the information gathered from past, present and future information to be cross-referenced via cross-referencing to other consumer(s) that have similar information/characteristics to determine these consumer(s) past, present and future stats. The space stats will cross reference consumer home/office style(s), occasion(s), color(s), shape(s), pattern(s), measurement(s)/dimension(s) and/or surface type(s)/material(s) with the virtual space product/service style(s), occasion(s), color(s), shape(s), measurement(s)/dimension(s) and/or surface type(s)/material(s).

Personal information which can be gathered about a consumer, can include:

| | |
|---|---|
| Social Security Number | Lifestyle preferences |
| Shopping preferences | Hobbies (whether and what the |
| Date of Birth | individual collects) |
| Sex | Homeownership |
| Age | Characteristics of residence |
| Weight | (size, number of bedrooms and |
| Household income | bathrooms, sale price, rent and |
| Race and ethnicity | mortgage payments) |
| Geography | Membership in book, video, |
| Physical characteristics, such as | tape, and compact disk clubs |
| height and weight | Product ownership (beeper, |
| Household occupants (whether an | contact lenses, electronics, |
| individual has children) | fitness equipment, recreational |
| Telephone number | equipment) |
| Consumer's space's Shape (body, | Pet ownership and type |
| face and facial features), Size, | Interests (including gambling, |
| Measurements, coloring (hair, eye, | arts, antiques, astrology) |
| skin), favorite colors, favorite styles, | |
| favorite patterns, favorite companies, | |
| favorite product, favorite product | |
| types, favorite occasions (holidays, | |
| birthdays, events, etc.), favorite | |
| patterns | |

Consumer physical characteristics can include age(s), gender(s), height(s) color(s), shape(s), measurement(s), dimension form(s), surface(s), texture(s), size(s) and weight(s) of a consumer that will be saved in UCode. Consumer preference characteristics can include style(s), occasion(s), color(s), pattern(s), shape(s), measurement(s), surface type(s), additive(s), surface material(s), texture material(s), occasion(s) preferred by a consumer for a beauty product/service that will be saved in UCode. Consumer Match Characteristics—style(s), occasion(s), color(s), pattern(s), shape(s), measurement(s), surface material(s), texture material(s), additive(s) preferred by a consumer for a beauty product/service that will be saved in UCode.

Moreover, space physical characteristics can include style(s), occasion(s), color(s), pattern(s), shape(s), measurement(s) and surface type(s) of a space saved in SpaceCode. Space preference characteristics—style(s), occasion(s), color(s), pattern(s), shape(s), measurement(s), surface type(s), price preferred by a consumer for an interior/exterior product/service saved in SpaceCode. Space match characteristics can include style(s), occasion(s), color(s), pattern(s), shape(s), measurement(s), surface type(s), price preferred by a consumer for an interior/exterior product/service saved in SpaceCode.

A next feature of the present disclosure is analyzing data of a space, consumer, retailer or service provider or data of an associated product or service. It is thus contemplated that the present system and method can include a technology that will utilize a predictive, search, decision engine, pattern recognition, pattern matching, image generation matching, consumer profiling, algorithms, AIDC and/or unique product identifier matching and/or any other technology to determine the characteristics/data/purchase stats/consumer stats associated with the space, consumer, product or service and will best match with the space, consumer, product and/or service. The same can be used as cross-referenced and cross-referencing as well.

For instance, referring to FIGS. 1A-5, a consumer 100 could want a 2D or 3D image of themselves (consumer), consumer's space, consumer product(s)/service(s) or space product(s)/service(s) and takes a photo of the consumer, consumer's space, consumer product(s)/service(s) or space product(s)/service(s) with one side-view photo (profile/y-axis), and one front-view (x-axis) photo to form a 3D or 2D depiction of the consumer, consumer's space, consumer product(s)/service(s) or space product(s)/service(s) called Virtual Consumer, Virtual Space, Virtual Consumer Product(s)/Service(s), Virtual Space Product(s)/Service(s), respectively. The system will be able to utilize one camera to calibrate all the measurements of the consumer, consumer's space, consumer product(s)/service(s) or space product(s)/service(s). It will utilize recognition systems to determine where the measurement is and what it is measuring.

Once the consumer enters one measurement of say a head's height from chin to the top of their head, excluding the hair. The consumer could then take photo of their head. From this photo the dimension measurement could derive every measurement of the frontal image measurements and any measurement from the side image (profile). These measurements would create a 3D or 2D image of the person that can utilize dimensional movement to be moved in 360 degrees on the z-axis, with the center of the head being the z-axis. Since this can produce depth measurements from the side view (profile), it will be able derive the consumer's shapes for the consumer's face and facial features. It will even know sizes related to the head like hat sizes. In one approach, the photo should be taken without any hats or glasses and a background that is a contrast from the consumer's skin tone for proper face recognition to determine the sizes, shapes, 2D/3D image and measurements of the face/head/facial features.

If a consumer needs sizes, shapes, 2D/3D image and measurements of anything for beauty product(s)/service(s), the consumer could take a side image and front image of the consumer's entire body and put in the system the height of the consumer without any hats or shoes and tight clothing where a background was a contrast from the consumer's skin tone for proper body recognition. This would recognize the sizes of clothing, the shape of the body, create 2D or 3D image and measurements entire body. This can also be done by taking a side view or front view of either of interior/exterior product(s)/service(s) or beauty product(s)/service(s) and taking the height or z-axis measurement of the product(s)/service(s) to derive their sizes, shapes, 2D/3D image and measurements.

For example, as shown in FIGS. 1A-C, a service provider 102 can finish the look of a consumer 100. Next, the service provider 102 uses a camera or computer 104 to create an image generation 106 front and side view (side view for 3D) and adds such data to UCode and/or Service Code. At a later date, for example three months later, the consumer or service provider accesses USpace Lookup (or other database) under UCode and Service Code to review the image that was saved. The height of the head or other dimensions are considered and the image is removed to determine haircut, style products utilized etc. The consumer 100 or service provider 102 clicks on various sections of the image and products appear.

Other image collection devices are also contemplated. As shown in FIG. 2A, a UConsole 200 or UTV 202 can be provided and configured to cooperate with UHome, USStore, URStore functions (beauty or interior/exterior design) and to capture or scan full body, full space and full product and decorating aspects. Such devices can be adjustable in height or size to best capture images. Image generators 210 can be spaced (equally or otherwise) about the image capture devices 200, 202. Also UCode, ProductCode, ServiceCode, AIDC, Software or other database 220 can be added to the devices, and the devices 200, 202 can be mounted or be provided with styles.

The image capture and generator system can also include a rotating UPlatform 230 (FIG. 213). The platform can rotate in either direction and at varying speeds, stopping when desired. The platform can have various sizes and can be adjustable in height, and can further include a rubber surface and a scale. A center console 250 equipped with an image collecting device can be further provided so that data can be gathered as the platform 230 rotates.

Further, as shown in FIG. 3, an image capturing device can be embodied in a full-body scanner 300. Such a scanner can be placed in a store or at a service provider. A platform 302 is provided in the center of the scanner 300, and a plurality of image generators 310 are placed within the scanner 300. The platform 302 can be configured to rotate or a sufficient number of image generators 300 can be provided to get a 360° view of the consumer generated. The platform 302 as before can further be equipped with a scale. Various booths 373 with computer access can further be provided about the periphery of the scanner to provide a space to perform consumer activity.

Additionally, as shown in FIGS. 4A-C, image capturing can generally be accomplished using a computer 330 or other laptop device. As will be described more below, such a computer 330 can be equipped with various applications for communicating consumer wants and needs using UPP, USPP or URPP for beauty or interior/exterior design and decorations, for example. Thus, it is contemplated that the computer 330 includes an image generator 332, and the consumer will turn to capture necessary images or the computer moved to capture other images (See FIG. 5).

In one or more specific approaches, the device whether a laptop 330 (FIGS. 3A-C) or a mobile phone device 600 (FIG. 9) can include UApp, URApp, or USApp programming from which a consumer 100 can conduct purchasing or commercial activity. The device 330, 600 creates a SpaceCode/UCode, ProductCode or ServiceCode depending on the user. Personal products or interior/exterior design and decorating products/services with characteristics related to the consumer, retailer or service provider are stored and accessed to accomplish desired commercial activity. Flow charts of such contemplated activity are provided in FIGS. 10-13.

By taking the height of ceilings, one can determine the height and widths interior/exterior product(s)/service(s), by taking a side view and front view of a door for example one could determine the length=height, width and depth. One could actually take any z-axis measurement and a side-view photo along with a frontal photo to determine sizes, shapes, 2D/3D image and measurements. The product can also be portrayed from a consumer's device into a hologram, so as to provide a 2D/3D hologram of the product/service/consumer/image size, shape and proportions (See FIGS. 6A-B, for example). The colors will be portrayed the same as the image. If there is no image of the product's side view but only a clear image of the frontal view with any referenced measurement such as the height (z-axis) or width (y-axis), the system can provide the consumer with a clear view of the product's 2D hologram, by computing the dimension measurement with the width or the height. Likewise, if there is no image of the product's frontal view but only a clear image of the side view with any referenced measurement such as the height (z-axis) or width (y-axis), the system could provide consumer with a clear view of the product's 2D hologram by computing the dimension measurement with the width or the height. Further, if the image is a video and the video has one of the referenced dimensional measurements from above, the video will be able to be shown in 2D/3D hologram. It will have the capability to recognize the image's dimensions by searching for dimensions via image recognition and optical character recognition. It will also have the option for consumer to enter in the dimensions of the product/service.

In one example, hologram technology can be employed to identify and then place a product such as a coffee maker within a space for a consumer. As shown in FIG. 6A, a computer 350 equipped with hologram technology is accessed and a desired coffee maker is displayed from amongst various considered devices. It is of course recognized that holograms can be used to show products either in 3D or 2D 352 and in various sizes, where consumers prefer or where the product, service, or consumer is supposed to be located or where the hologram needs to or can be placed based on the items dimensions. It is also contemplated that the consumer can interact with the projected image such that for example, pushing a button on the projected coffee maker causes the device to function or move. Thus, it is contemplated that the database containing the coffee maker includes an interactive video of a functioning device. Moreover, product details can be recognized from a scan of a desired product and cross-referenced with devices available for purchase. For example, particular buttons or size or shapes of desired devices can be searched (using AIDC) to find specific items.

Moreover, the present system can include one or more image generators to depict a home or office in 2D or 3D with the ability to move in includes products/services in a consumer's/consumer's/retailer's/service provider's home or office including the interior and exterior areas of the home or office where there are product/services that a consumer/retailer/service provider purchases. A depiction of a real home, office or any other space showing in 2D or 3D with dimensional movement including Home Interior, Home Exterior, Office Interior, Office Exterior and/or Interior/Exterior Design of the home or office in 2D or 3D with dimension movement by utilizing a device to show an image from an image generator or show an image from data from an AIDC and/or unique product identifier, database or software. The system can also provide a depiction of a consumer shown in 2D or 3D with dimensional movement by utilizing a device to show a consumer from an image generator or show a consumer from data from an AIDC and/or unique product identifier, database or software. Additionally, any product or service such as Make-Up product/services, Nail product/services, Hair product/services, Body product/services, Apparel/Clothing product/services or Accessories product/services that is utilized on a virtual consumer can be portrayed virtually. Services and Products will utilize USpaceLookup, a searchable database is contemplated to be incorporated into the system. Also, any product or service such as products/services listed under Home Interior, Home Exterior, Office Interior, Office Exterior and Interior/Exterior Design under the Interior/Exterior Product/Service that is utilized in a virtual space by being portrayed virtually. Services and Products will utilize USpaceLookup.

It is further contemplated that the system includes a technology that can show a consumer the consumer's virtual consumer with a consumer imaging generator/consumer's UCode what Make-Up product/services, Nail product/services, Hair product/services, Body product/services, Apparel/Clothing product/services, Accessories product/services in a virtual dressing room to see if the product/service match the characteristics of style, occasion, color, shape, measurements/dimensions/size, surface type/material, pattern and/or weight that the consumer is seeking in product/service. In “Virtual Try-On” the consumer can try-on clothing to be shown on any device in 2D or 3D form with Dimensional Movement.

In another embodiment, the system can show a consumer the consumer's virtual space with an Interior/Exterior product/service (Any Virtual Space Product/Service) imaging generator or Interior/Exterior ProductCode/ServiceCode what Interior/Exterior product/service (Any Virtual Space Product(s)/Service(s)) would look like in a virtual space, or a hologram of an Interior/Exterior product/service would look like in their home or office via utilizing devices (devices definition mentioned below). In “Virtual Space Try-On” the consumer will select the location where the consumer would like the Virtual Space Product/Service in the consumer's home/office by selecting a location on an imaging generator such as a video camera visualizing the consumer's home and it will show the consumer what the product/service looks like through the video camera. This method would all be done virtually through the consumer's device, whereas the next way to portray an object will show a virtual product/service within a consumer's actual home. It is to be recognized that this could be done another way by with a hologram as well where the consumer selects the location in the consumer's home/office to place a virtual product/service and a hologram could portray to the consumer what the virtual space product/service would look like in the consumer's actual home.

In certain embodiments, a consumer can also rank a service provider/retailer from on a sliding scale of percentages 0%-100% Customer Satisfaction to be exchanged with the consumer sphere of people or to be shared via email, instant messaging, social media sites or any other social media site or other consumers that purchase similar product/services that can be categorized by characteristics and linked to the service provider's ServiceCode/product's ProductCode and consumer's UCode. This approach is intended to create communication and information exchange between service providers and consumers. In another aspect of the present system, there can be coordination of the product/service purchased and consumer and suggesting these to consumer. These aligning of product(s)/service(s) pertain to the location of the product in the space. These aligning product(s)/service(s) also pertain to the location of the product on the consumer i.e. body or face, i.e. which facial feature or body part, company type: Product(s) and Service(s) in Make-Up, Nails, Hair, Body, Apparel/Clothing, Accessories, Shoes and/or Beauty (Product(s) and Service(s) in Beauty would be all company types). For aligning product(s) and service(s) there can be a correlation of other products for consumers that work with the product/service purchased and suggesting these to service provider, retailer and/or consumer. Example of consumer's space: A couch purchase would suggest pillows to match (both products for the living room) or art purchased suggesting framing service (both deal with art in products/services) or window installation suggesting curtain installation (both deal with window). Example of consumer beauty: an eyebrow pencil purchased suggesting a tweezer (both products for the eye) or waxing purchased suggesting tweezing service (both types of waxing) or nail polish purchased suggesting a manicure (both deal with nails).

The retailer's/service provider's information that the retailer/service provider or consumer chooses to register under the retailer's/service provider's or consumer's database associated with the retailer's ProductCode/Service Provider's ServiceCode or consumer's UCode is up to the retailer's//service provider's or consumer's preference on privacy. Retailer/service provider can choose what information will be exchanged to the consumer's UCode. Consumers can choose what information will be exchanged to retailer's ProductCode/Service Provider's ServiceCode. Consumers can also rank retailer's products/service provider's services on a sliding scale of percentages 0%-100% Customer Satisfaction to be exchanged with the consumer's sphere of people by email, instant messaging, social media sites or other consumers that purchase similar products/services that can be categorized by characteristics and linked to the retailer's ProductCode/Service Provider's ServiceCode and consumer's UCode. This creates communication and information exchange between retailers, service providers and/or consumers. Now this product/service the consumer purchased is associated with the consumer and retailer/service provider and the consumer is associated with retailer/service provider. Lastly, the retailer/service provider is associated with consumer. All allowed information can be transferred across all retailer devices/service provider devices and consumer devices.

The system can be configured to also provide tutorials. For example, a tutorial dealing with the consumer's beauty can use the consumer's 3D or 2D image to portray the consumer, and what the consumer has questions about concerning how to personalize their beauty for consumer's age, gender, style(s), shape(s), color(s), surface material(s), surface texture(s), occasion(s) and pattern(s) or group the characteristics together along with preferences, matches and physical characteristics to create a look. The consumer can select what the consumer is going for in each characteristic. The device will scan the actual consumer. The device will look via image recognition, USpaceLookup, ProductCode, UCode, ServiceCode or other AIDC and/or unique product identifier, database, software or website pertaining to consumer recognizing a product or service for products and services that would reflect these characteristics online through selected retailers and service providers or search the entire ADICs, software, internet or database of a certain website with many products or services like Amazon for a website. This will ultimately show step by step how to beautify the consumer on what the consumer asks about via a consumer tutorial utilizing the actual consumer image to ultimately give the consumer an overall look virtually via the tutorial and shows what order to utilize products and services for the consumer based on consumer characteristics, stats and information. For example, foundation prior to powder, service treatments prior to overall look with products, etc. Products or services might pertain to Make-up, Nail, Apparel, Body, Accessories and Shoes. This can be given in a partial or overall look.

An example of a tutorial dealing with a consumer's space can involve using the consumer's space's 3D or 2D image to portray what the consumer's space has and posing questions concerning how to decorate/design for the space's style(s), shape(s), color(s), surface material(s), surface texture(s), occasion(s) and pattern(s) or group the characteristics together along with preferences, matches and physical characteristics to create harmony, rhythm and balance in a space. The consumer can select what the consumer is going for in each characteristic. The device will scan the consumer's actual space. The device will look via image recognition, USpaceLookup, ProductCode, SpaceCode, ServiceCode or other AIDC and/or unique product identifier recognizing a product or service for products and services that would reflect these characteristics online through selected retailers and service providers or search the entire internet or database of a certain website with many products or services like Amazon. This will ultimately show step by step how to design and decorate the interior/exterior space asked by the consumer and answered via the tutorial utilizing the actual consumer's space to ultimately give the consumer's space an overall look virtually via the tutorial, and shows what order to utilize products and services for the consumer's space based on consumer's space's characteristics, stats and information dealing with designing and/or decorating. For example, paint prior to laying down wooden floors, design before decorating, etc.

In various other embodiments and examples, the system can enable the consumer to give permission to share with others the consumer's space's stat/consumer's stat information, characteristics and/or the product(s)/service(s) the consumer/consumer of a space has already purchased to find product(s)/service(s) that would work with the consumer that is similar to the consumer/consumer's space. A similar consumer/consumer's space may have similarities in characteristics. The consumer/consumer's space can share with similar consumers, family and friends a Wish List of product(s)/service(s) the consumer would like to purchase. The consumer/consumer of a space can share their consumer stats/consumer space stats with guests by knowing all the consumer's/consumer's space's characteristics without using the exact product(s)/service(s) from wish list for a surprise purchase.

The consumer can also choose what Contact Information, Match (The product(s) that show(s) up on the consumer's device will look best on the consumer by comparing the consumer's physical characteristics and product/service criteria or UCode to the product(s)/service(s) via their productcode/servicecode to come up with what's called a Match) and preferences (The characteristic attributes that the consumer prefers (preference): likes or dislikes. A Match/Preferences is designed to cross-reference the consumer and product/service to determine the best product/service), Items Purchased or Wish List the Consumer would like to share with retailer/service providers for coupons, advertisements towards the product/service on the wish list and how often the retailer/service provider selected is allowed to contact the Consumer. A list of service providers and retailers and even more narrowed down to products and service provider individuals will be listed that the consumer has chosen as the consumer's favorite. Consumer will have the ability to rank Retailers via ranking the retailer's products to be associated with the ProductCode and Service Providers via ranking the service provider individuals to be associated with the ServiceCode and give a written review. Also, one can view other consumer's rankings via social media platforms or a personalized social media platform for shopping.

The system can recommend similar consumers with similar UCodes to become consumer favorites. Consumer will be able to see what other consumers with similar UCodes have ranked certain products the consumer is questioning purchasing by cross referencing a UCode of the consumer with a UCode of the other consumers to find similar consumers with product purchase that's in question that has a review/ranking by that similar consumer. The consumer will be able to see what other people with similar UCodes have purchased recently. The consumer will be able to see what product celebrities have purchased with similar characteristics and/or similar product purchase. The consumer will also be able to interact via the device with consumers with similar product purchase and/or similar characteristics to video chat, email, instant messaging, text, send images on a social media platform or other software, and can be able to share/review/rank product's the consumer has purchased.

The system can also be configured to show how to wear trends that are best for the consumer based on the consumer's characteristics. Each section will show current and upcoming season's trends (up to a year) for the particular section discussed below, if the trend is “It Fits You”/Match. If the item in season or next season does not “It Fits You”/Match the consumer's stats the item will not be shown in Matches or will utilize layering for “It Fits You”.

The system can enable the consumers to choose how often retailers/service providers can contact the consumer. Also, using the system, the consumer can choose what kind of contact the retailers/service providers can make like coupons, advertising, events.

Purchase stats can be tracked by the system and can deal with information pertaining to the consumer. Purchase stats could be derived from consumer profiling. Purchase stats will organize consumer purchases for the consumer's beauty product(s)/service(s) and interior/exterior product(s)/service(s), but can be utilized in any utility (product or service). In one approach, the system finds the products/services and product type/service type and company with product or service the consumer purchases or is on the consumer's wish list/cart to purchase; creates an inventory of these products/services categorized under product type/service type and further categorized by company with product or service the consumer purchases; creates a timeframe of when the products or services from each product type/service type under each company with product or service the consumer purchases that were purchased; utilizes the inventory and the timeframe to determine when the consumer needs to purchase a product or service under a product type/service type under a company with product/service; retains information on the average of what the consumer spends on each product/service or product type/service type or company with product or service called the consumer's price point; cross-references the timeframe with the product/service with what the consumer shows in the inventory as needing with the what the consumer spends with products/services with various companies with the same type of products/services organized by company rank, product rank, product type rank and price relating to the particular product or service; and cross-references purchase Stats with a product entry/service entry/product code and/or service code.

Consumers will be able to share their consumer purchase stats or when the consumer is looking for a product or service with family, friends, etc. that would like to purchase them a product or service, or similar consumers by cross-referencing the consumer's purchases to find consumers with similar purchases. Favorite retailers and/or service providers can be tracked and consumer purchase stats can be used to promote when a consumer is looking for a product/service by updating the people they share with whether the consumer has purchased or the last time they looked for the product. A consumer can be ranked by percentage on the consumer's returns for each product/service, product type/service type and company product/service. Moreover, certain consumers can have better knowledge of certain products/services from use and can be able to share consumer purchase stats with other consumers/family/friends/retailers and/service providers. Consumers may then be able to negotiate with retailers or service providers on price. It is also contemplated that these consumer purchase stats will be accessible via any device or technology that can utilize this data. Also, this information can be stored to a database, software, associated internet website or AIDC and/or unique product identifier. Also, the system can be configured to receive data to personalize a service provider or retailer and/or service or product to a consumer.

A Retailer/Service Provider will be able to see what product(s)/service(s) is/are a match to a consumer that's in the store or online by cross-referencing the retailer's ProductCode/service provider's ServiceCode of an individual product/service or all the retailer's products/service provider's services with the consumer's UCode, if the consumer agrees. The Retailer/Service Provider can create or reference a consumer's UCode on any device if the consumer agrees. The system will give a retailer/service provider consumer's information via UCode and app will give the consumer retailer's/service provider's information via ProductCode/ServiceCode (if consumer, service provider and/or retailer chooses to share). If the consumer registers retailer's/service provider's company as one of the consumer's favorites, the retailer's ProductCode/service provider's ServiceCode will be saved in any device utilized by the consumer. If retailer/service provider registers consumer as one of the retailer's/service provider's favorites, the consumer's UCode will be saved in any device utilized by retailer/service provider.

Based on previous products/services purchased or wish list, a Retailer/Service Provider can send the consumer an email, mailer, message with coupons, events and advertisements on a consumer device with specials on Match and/or Preference products/services, Products/Services Purchased or Wish List and events with Match and/or Preference products/services. This retailer/service provider registration to a consumer will create a RSUTag associated with username and password/AIDC and/or unique product identifier and ServiceCode via ServiceEntry, USpaceLookup, and/or ProductCode via Product Entry. The system can recommend a Retailer/Service Provider to other retailers and service providers to be the retailer's/service provider's favorites with similar company fields and/or stats of company by cross referencing Retailer/Service Provider company fields and/or stats of company. The Retailer/Service Provider will be able to see what the retailer's/service provider's favorites have purchased for the company recently and the retailer's/service provider's favorite's ranking. The Retailer/Service Provider will be able to interact via social media, instant messaging and/or email the Retailer/Service Provider will be able to share/review with other Retailer/Service Provider product(s)/service(s) the retailer has purchased. Thus, a retailer/service provider that sells to consumers can link with marketers, advertisers, investors, etc. that serve retailers/service providers through their retailer's/service provider's favorites and align product(s)/service(s) and retailers/service provider's that service consumers can link to similar retailer/service providers through their retailer's/service provider's favorites. Also, a retailer/service provider can link with their consumer's to see what they have purchased recently, what's on their wish list, consumer's ranking, share consumer, review consumer, will be able to interact with consumers via social media, instant messaging and/or email. The consumer has the option to unlink with retailer or service provider at any time.

A retailer or service provider using the system can be able to determine the product's StyleCode, OccasionCode, ColorCode, ShapeCode, Dimension/MeasurementCode, SurfaceMaterialCode, PatternCode or utilize ProductCode to be stored into the ProductCode via a product entry process for UCode. This product entry process will create a ProductCode associated with username and password, database, website, AIDC and/or unique product identifier and/or software. The retailer or service provider can enter, scan or transfer all the data of the retailer's product(s) via RSUTag, ProductCode or other AIDC and/or unique product identifiers like a QRCode, UPC Codes, barcodes, etc./software mentioned into the system or the retailer can enter the retailer's social media site to generate some of the information to be transferred to device. The retailer will be able to create a ProductCode. The system will recognize a location of the company via GPS and search the internet via an algorithm to see if the retailer is a distribution center, retail store, company office, warehouse, etc. and confirm with the retailer. The retailer can confirm company name, website, company type and address via the device from the referenced location and information. If the retailer company is not determined via location, social media or RSUTag, ProductCode or other AIDCs and/or unique product identifiers, the system can ask the retailer to input location, company name, website, address and company type (distribution center, retail store, company office, warehouse, etc.) The system can determine product style and/or occasion (if applicable) and products via the company name by searching the web for related words describing the style and/or occasion of the company. If the system cannot determine style and/or occasion of a company and products via company name or searching the company website or social media site, the system will ask the company to choose one or many selections from many different styles to decipher the company's overall style (chic dress whereas chic is one of the style) or occasion. This input will generate tags if the consumer would like to search for a style or occasion via a device. The system will determine company products via the company name by searching the web for related words describing the products of the company like Make-Up, Nails, Hair, Body, Apparel/Clothing, Accessories and Shoes. This input will generate tags associated with the retailer ProductCode, if the consumer would like to search for these products the consumer can search via the tags and the device will place the products in Sections, sub-sections and sub-subsections (referenced in Product Entry) via cross-referencing the tags for consumer personalization on devices. The system will ask for the company's z-axis measurement and an image of the Apparel/Clothing, Accessories and Shoes to do a dimension measurement to determine all physical characteristics of product and create 2D/3D dimension images (Virtual Consumer Product(s)) of products including holographic images that would be saved to the ProductCode to determine a match of the product to the consumer via the consumer's UCode. The system would have to gather the company's size chart for their products or other measurement data along with an image of the product to create a 2D or 3D image (Virtual Consumer Product(s)) of the product along with holographic images of product that would be saved to the ProductCode to determine a match with consumer's UCode. The system could also create an image generation via scanning in the product to determine all the physical characteristics of the product to create a 2D/3D image (Virtual Consumer Product(s)) of the product along with holographic images/streaming videos (explained in that would be saved to the ProductCode to determine a match with consumer's UCode. A ProductCode Retailer or Service Provider will also be able to save Products to ProductCode via scanning the AIDC and/or unique product identifier or USearch. The system will determine product recognition via input from retailer or scan or camera or other visual imaging entity or AIDC and/or unique product identifier lookup. The system will ask the retailer to select the type of Make-Up, Nails, Hair, Body, Apparel/Clothing, Accessories and Shoes if not determined via AIDC and/or unique product identifier, database, internet, software or USearch or imaging recognition associated with product and uploads an image of the product the retailer would like to register. It is also contemplated that the Service Provider's/Retailer's personal profile will evaluate the product/service/consumer in a step-by-step process by using the service provider's image generation device to register consumer.

Next, the system utilizes data to determine the “It's you”/Match/Preference/physical characteristics that match by cross-referencing (definitions) the characteristics of a space, consumer, product and/or service to the match/physical characteristics of a space, consumer, product and/or service. The system can show a consumer what characteristic attribute matches the consumer or how to use layering on characteristic attributes that do not match the consumer. If a consumer's “It Fits You” is not a match for any of the consumer's physical characteristics, the device will utilize layering of product(s)/service(s) to make the product(s)/service(s) a better match. The consumer could have matches in certain products/services for the body, face, facial features, hair and nails such fabrics like leather, cotton, suede, etc. as their skin might be allergic to material. If they prefer this material the software would know to use the layering technique and put fabrics in between their skin and the allergic fabric. For example, the system may determine that skinny jeans for a pear shaped body is not a match. The device will suggest with a dark wash near upper part of bottom and a lighter wash near lower part of jean or will ask if it would like to layer another product since this preference is not a match. If layering could put dark skinny jeans with light knee high boots. The layering option given would be the light knee high boots.

In yet another further aspect of the system, a “Go Shopping” Technology is provided. Go shopping can be retrieved, stored or transferred via aforementioned device or technology. So when a consumer is shopping at a store, home or any remote location, they would merely need to walk into a business like a mall or store/shop online or via data and the productcodes/servicecodes or associated AIDC and/or unique product identifier/software/database/internet website would cross-reference what is low on the consumer's inventory, what's on the consumer's wish list or cart to show the consumer possible choices that match their criteria that the consumer can delete if no longer interested. The consumer's products/services in the wish list/cart will also be flagged when these items go on sale to notify the consumer via email or text or a message on the application, software, database, AIDC and/or unique product identifier or device. Example of a criteria of a consumer could be a rating of customer satisfaction of product ranking of a t-shirt above 80%, price with coupons at below $12, style: All-American, Occasion: None given, Color: Match Colors or Color Preference for the consumer since it's clothing, the consumer chooses orange from a range of colors selected for the consumer as match colors, Shape: Best Shape: Short V-Neck, Dimension/Measurement: Size: Small, possibly derived from the consumer's dimension measurement or other means mentioned, surfacematerial: Cotton, can chose more than one, Weight: No updated weight, Additive: NA. The device would then find the T-shirt in the mall the consumer is at by giving them various options and even advertisements. Criteria of a consumer in various services could be a service provider ranking, price, style, Occasion, Color Match/Preference, Shape Match/Preference, Dimension/Measurement, surfacematerial, Weight, Additive. These criteria could also be given in ranges and depending on the service the criteria may not be accessible or applicable. Once the consumer selects a product, the consumer will have the option to be routed to the exact location in the store of the product with available inventory, if the store is open. These criteria could also be given in ranges. Once the consumer selects a service, the consumer will have the option to be routed to the exact location in the store of the service with a scheduled time the service provider has verified. This could be done at any remote location finding nearest business or within the store. This service's/product's associated AIDC and/or unique product identifier, software, database, internet website will be saved to the consumer's AIDC and/or unique product identifier, software, database, device storage for future reference with all contact information.

The consumer can also be able to search products/service by the type of product/service, product ranking/service provider individual ranking, product Match/service Match of consumer/consumer's space to product and product price or product/service criteria or utilizing the data type that is in a ProductCode/ServiceCode or other AIDC and/or unique product identifier/software/database or via the internet. The consumer will be able to select product/service criteria and compare product/service provider individual with other product/service provider individual with the attributes of the product/service criteria. This system will show only products that are a match in characteristics. The consumer will select a product/service. The consumer will select a type of product/service narrowing it down by section, subsection, sub-subsection.

Using the system, the consumer would also be able to scan a database, software, associated internet website or AIDC and/or unique product identifier of a beauty (beauty includes makeup, nails, hair, accessories, body, shoes and apparel) product or take an image of the product (while the consumer is wearing the product) and how the product functions or with an Interior/Exterior decorating or design Product to show what a product would look like in a space and how the product functions. This can be used with any product/service in any field, besides the beauty and interior/exterior decorating and design areas of the SIC. This technology will also be able to determine the product's characteristics of matches, preferences, and physical for a consumer or consumer's space. This technology for consumer beauty products will portray a holographic image of the product over the consumer and be able to put a holographic image of the product on the holographic image of the consumer/virtual consumer to determine if the product is a match and/or “It Fits You” by the consumer's physical characteristics and/or preferences and give the consumer a visual. This technology for space products will portray a holographic image of the product in a space and the consumer can interact with the hologram by turning the hologram TV on or any other device or product via touchable technology that recognizes a person and moves the hologram to react with the person's behavior like pushing buttons on a device would show the product working via streaming a video of the object overlaying the actual product/device to make it a 3D hologram of the actual product functioning. So if it is desirable to see how a coffee machine works, but one does not want to go to the store or have the ability to see it work with holographic coffee, one would simply make a hologram of the product, use touchable technology to recognize the person pushing on buttons of the device, opening drawers, turning on switches or any other interaction a person can have with a product, then the streaming video of the product recognized by image recognition on the web or via a particular retailer would display the product's corresponding video when the exact button, handle, switch, etc. was interacted with through touchable technology, but alter the video from 2D on the screen to 3D via dimension measurement and dimensional movement in the location the person prefers it to be displayed. Now one can actually see a virtual coffee maker make virtual coffee with a person's interactions on how they would react to any other product in the location the product would be normally allocated to judge measurements and such. One can also determine if it's a match/preference or fits a person's criteria, purchase stats via match and/or “It Fits You” or criteria of person, purchase stats for beauty and interior/exterior products. This could also work for watching TV on a virtual screen. Thus, there may be no need for a physical TV when you can have a virtual TV/computer/any other device. In fact, retailers could submit videos of a model interacting with a product to align with the touchable technology to be able to have the consumer is interacting with the product at their own convenience and location.

Concerning a hologram that portrays in front of a consumer (not overlaying on a consumer), the system of the present disclosure would utilize some type of recognition (i.e. facial recognition, etc.) via the device's image generation to see where the consumer or other people in the room are located to project the streams of light (the hologram) in front of the consumer's eyes, so the image of the product would be how the consumer would see the product in everyday life even without glasses to view. This technology would also enable 360 degree viewing of a product/service.

It is further contemplated that the technology could involve body recognition, which would recognize where the body is located from the device. This device will also have space recognition which will recognize products in a space and determine the type of space like where a bed goes in a bedroom. The productCode would have a corresponding representation of the location the product is supposed to be put on the consumer and would have a corresponding representation of the location the product is supposed to be put in the space. The hologram would overlay the product on the consumer on that location for a visual for the consumer in 2D or 3D and for the device/consumer and to determine if the product is a match and/or “It Fits You” or put the product in the corresponding location in the space to determine if it's a match/or “It Fits You” for the space. This can also be done with Services from the image generation that has been stored in a ServiceCode or USpaceLookup to create a holographic image of the product on the location specified from the ServiceCode onto the consumer or into the space. These holographic images will be saved in the associated ServiceCode and/or ProductCode or other AIDC and/or unique product identifier or software/database of a device. The system can have a saved holographic image from a previous image generation of a consumer or a consumer's space or online from the internet. The productCode could have a corresponding representation of the location the product is supposed to be put on the consumer or in the space. The hologram would overlay the product on the consumer's holographic image on that location for a visual for the consumer to look at in 2D or 3D and for the device/consumer to determine if the product is a match and/or “It Fits You” or place the product/service in the consumer's space to determine if it's a match/or “It Fits You”. This can also be done with Services from the image generation that has been stored in a ServiceCode or USpaceLookup to create a holographic image of the product on the location specified from the ServiceCode onto the holographic consumer or in the consumer's space. These holographic images will be saved in the associated SpaceCode, UCode, ServiceCode and/or ProductCode. This information can be stored to database, software, associated internet website or AIDC and/or unique product identifier.

The system can include a feature which can be used with any product/service in any field. This can be utilized on any device or technology that can utilize utilizing UFind also including but not limited to UApp, UPP, UHome, UStore. USearch can include company recognition which will recognize the company name, label, brand, logo, product name, product type from a scan, and after company recognition, the system will connect the company's database, software, associated internet website or AIDC and/or unique product identifier and Product/Service Criteria (Space) of the company under the same database, software, associated internet website or AIDC and/or unique product identifier. In this way, a consumer could search for products on the internet similar to or be directed to the exact product the consumer currently owns by image generation or any other AIDC and/or unique product identifier recognition of the product that recognizes the product by its characteristics and possibly cross-referencing with recognizing a company name/company label/logo/product name/product label (if any is given in the image generation, if not it would ask the consumer to enter the company name) and could also scan the associated product AIDC and/or unique product identifier for what's called company recognition to search the company AIDC and/or unique product identifier with characteristics for exact product, scanning the AIDC and/or unique product identifier of the product, productcode, RSUTag. For example, a consumer breaks a Waterford Crystal Glass. The consumer would input Waterford as the company name might not be visibly on the glass for the scanner to find. Then the scanner would determine that the surface type is glass, the shape of the glass, the measurements of the glass, the color of the glass, weight of the glass would determine its crystal to cross-reference searches of glass with Waterford with images that had the same surface type, shape, measurements, color, weight to find the Waterford Crystal Glass the subject is looking to purchase. Products that need to be in packaging or their cases to be identified would need to have an image generation. This technology can be utilized for any purchase of any tangible product such as hair coloring by scanning the hair coloring box by scanning the relevant AIDC and/or unique product identifier or RSUTag. Thus, if there's a company that's selling it with the image of the bottle or if AIDC and/or unique product identifier or RSUTag is on the bottle or an antique by searching via brand if available and/or the (image generation) or clothing by searching brand and/or the image generation and/or AIDC and/or unique product identifier or RSUTag if it still has its tags or plant by brand and/or the image generation and/or AIDC and/or unique product identifier or RSUTag if it still has tags, etc. The consumer will have the option to purchase the product in the store nearby or online. The system will not only search the entire internet, but hone in on the brand's websites and online sales sites like Amazon, Ebay and Craigslist, etc. that have data for all products and/or services. It will also show the consumer more information about the product from the search if requested like Product/Service Criteria (Space). The information can be important because it can affect whether or not a consumer really wants to purchase a product/service and gets the consumer more informed about the product/service they are purchasing, so the consumer will be less likely to return product. This system will also show the best prices for the product/service with shipping plus original cost for purchase online. The system will have GPS to determine the closest place of purchase or obtain service, if they are purchasing or getting service in store. This system will consult with the stores to see what stores in your surrounding location have the product and/or left by comparing image generation and/or AIDC and/or unique product identifier or RSUTag in the store. Consumers can now find out where friends go when the store is not obvious or possibly find a product and/or that's no longer at the stores, but is being sold by an individual online.

In another aspect, the present system can include another feature called USpaceLookup. As stated, this can be a type of database, software, associated website or AIDC and/or unique product identifier that can be utilized with or inserted into any device. The UCode and SpaceCode will have a virtual depiction of the consumer or space called the Virtual Consumer and Virtual Space, respectively. This will show a visual image of the consumer or space with the products/services utilized in that space or on the consumer, Virtual Space Product(s)/Service(s) and Virtual Consumer Product(s)/Service(s), respectively. These Virtual Space Product(s)/Service(s) and Virtual Consumer Product(s)/Service(s) can either be recognized by image recognition, USearch, consumer for previous/current product(s) or service(s) for future reference or the Virtual Space Product(s)/Service(s) and Virtual Consumer Product(s)/Service(s) can be entered in by the retailer, service provider or consumer. The retailer that is selling the product can associate the UCode/SpaceCode by scanning the product's AIDC and/or unique product identifier or USearch and placing it in the specified location where it was utilized on the virtual consumer or in the virtual space via the consumer's UCode or SpaceCode. The Service provider that is selling the service can associate the UCode/SpaceCode by scanning in the product's AIDC and/or unique product identifier or USearch utilized in the service along with a visual image of the consumer or consumer's space to give a visual of the service and show where the product(s) were utilized during the service. This USpaceLookUp can be viewed on any system online or in store via image generation including viewing as a hologram. The consumer could also ask for the relevant documents and/or information to do the same scan and visual image as the service provider or retailer. These will all be associated with Product/Service Criteria Space and Product/Service Criteria. In one example, a consumer that got their hair cut, colored and styled three months ago can reference the USpaceLookup to see for themselves or show another service provider how to do the same cut with the same hair coloring products or a product that is similar with the image of the consumer, for instance, with a photo on a cellphone, smartphone, android or iPhone, the image might be in 3D/2D on the consumer's device. The products utilized for haircut, color and style could be Ion color Brilliance Liquid Permanent Hair Color 4N, Ion Sensitive Scalp 3% Developer, Ion hair cap, Ion Shears, L'Oreal Shampoo, L'Oreal Conditioner, Bed Head Hair Spray, Ion Round Brush, Chi Blowdryer and Chi Straightener. The style could be a short bob that would be shown in a photo on the cellphone. The products (ProductCodes) would be listed under the associated service for consumer/service provider future reference. The consumer could even click on the image of the consumer to see the products used and the type of services during the service. These would be saved in the consumer's UCode with the associated ServiceCode and ProductCodes under Hair. The image generators of the system would need an inputting device (such as a scanner) and an outputting device (such as a reader) for UCode(s), ServiceCode(s), ProductCode(s), SpaceCode and RSUTag to identify and data capture. USpacelookup can of course be utilized on any device or any technology that USpaceLookup can be utilized.

Another feature of the system is UOrganizer (See FIG. 7). This is a type of database, software, associated website or AIDC and/or unique product identifier that can be utilized with or inserted into any device. This feature will deal with any product/service that would assist with organization within an area in any industry. This will be for any area, not merely home and office areas to all products that are disorganized in any utility and find a product and/or service associated with the product type to organize the product. If there are products in a space that are disorganized, the consumer will click on these products once in the device's screen (image display, monitor, screen, viewing area, etc.) to recognize the product that is not organized. These products will be recognized via image recognition and suggest an appropriate product/service possibly storage unit by aligning the products that are misplaced/disorganized in the space to organizers/storage containers either that need to be installed by a service provider or purchased from a retailer for the particular product and place those product's via hologram technology in the area the consumer is organizing with the exact size of the product via dimensional measurement or the device's allotted size, or on the consumer's image display in the organizer/storage container to have the consumer visualize the organization within the consumer's space. The search for the product that is not organized can be done via a database, software, website or AIDC and/or unique product identifier.

In one example, at step 1, a consumer or other individual 100 will use an image capturing device and computer 400 to take a picture of a disorganization 405 with SpaceCode recognizing the room (for example, paper recognized by image recognition). The system at step 2 provides images of products the consumer/retainer can choose to effect a desired organization. At step 3, the user selects an organizer 410 and in this example, puts paper in the selected organizer Next, at step 4, the computer 400 projects the selected organizer 410 in the subject space 420.

Hologram Technology (See again FIGS. 6A-B)—This can be used with any product/service in any field. The consumer would also be able to scan a database, software, associated internet website or AIDC and/or unique product identifier of a beauty (beauty includes makeup, nails, hair, accessories, body, shoes and apparel) product or take an image of the product (while the consumer is wearing the product) and how the product functions or with an Interior/Exterior decorating or design Product to show what a product would look like in a space and how the product functions. This technology will also be able to determine the product's characteristics of matches, preferences, and physical for a consumer or consumer's space. This technology for consumer beauty products will portray a holographic image of the product over the consumer and be able to put a holographic image of the product on the holographic image of the consumer/virtual consumer to determine if the product is a match and/or “It Fits You” by the consumer's physical characteristics and/or preferences and give the consumer a visual. This technology for space products will portray a holographic image of the product in a space and the consumer can interact with the hologram by turning the hologram TV on or any other device or product via touchables technology that recognizes a person and moves the hologram to react with the person's behavior like pushing buttons on a device would show the product working via streaming a video of the object overlaying the actual product/device to make it a 3D hologram of the actual product functioning. So if you would like to see how a coffee machine works, but don't want to go to the store or have the ability to see it work with holographic coffee. You would simply make a hologram of the product, use touchable technology to recognize the person pushing on buttons of the device, opening drawers, turning on switches or any other interaction a person can have with a product, then the streaming video of the product recognized by image recognition on the web or via a particular retailer would display the product's corresponding video when the exact button, handle, switch, etc. was interacted with through touchable technology, but alter the video from 2D on the screen to 3D via dimension measurement and dimensional movement in the location the person prefers it to be displayed. Now you can actually see a virtual coffee maker make virtual coffee with a person's interactions on how they would react to any other product in the location the product would be normally allocated to judge measurements and such. Can also determine if it's a match/preference or fits person's criteria, purchase stats via match and/or “It Fits You” or criteria of person, purchasestats for beauty and interior/exterior products. This could also work for watching TV on a virtual screen. No need for a physical TV anymore when you can have a virtual TV/computer/any other device. In fact retailers could submit videos of a model interacting with a product to align with the touchables technology to be able to have the consumer is interacting with the product at their own convenience and location. Concerning a hologram that portrays in front of a consumer (not overlaying on a consumer), device would utilized some type of recognition i.e. facial recognition, etc. via the device's image generation is used to see where the consumer or other people are in the room are located to project the streams of light (the hologram) in front of the consumer's eyes, so the image of the product would be how the consumer would see the product in everyday life even without glasses to view. This technology would also enable 360 degree viewing of a product/service. The technology would have body recognition, which would recognize where the body is located from the device. This device will also have space recognition, which will recognize products in a space and determine the type of space like a bed goes in a bedroom. The productCode would have a corresponding representation of the location the product is supposed to be put on the consumer and would have a corresponding representation of the location the product is supposed to be put in the space. The hologram would overlay the product on the consumer on that location for a visual for the consumer to at the product in 2D or 3D and for the device/consumer and to determine if the product is a match and/or “It Fits You” or put the product in the corresponding location in the space to determine if it's a match/or “It Fits You” for the space. This can also be done with Services from the image generation that has been stored in a ServiceCode or USpaceLookup to create a holographic image of the product on the location specified from the ServiceCode onto the consumer or into the space. These holographic images will be saved in the associated ServiceCode and/or ProductCode or other AIDC or software/database of a device. The technology would have a saved holographic image from a previous image generation of consumer or consumer's space or online from the internet. The productCode would have a corresponding representation of the location the product is supposed to be put on the consumer or in the space. The hologram would overlay the product on the consumer's holographic image on that location for a visual for the consumer to look at in 2D or 3D and for the device/consumer to determine if the product is a match and/or “It Fits You” or place the product/service in the consumer's space to determine if it's a match/or “It Fits You”. This can also be done with Services from the image generation that has been stored in a ServiceCode or USpaceLookup to create a holographic image of the product on the location specified from the ServiceCode onto the holographic consumer or in the consumer's space. These holographic images will be saved in the associated SpaceCode, UCode, ServiceCode and/or ProductCode. This information can be stored to database, software, associated internet website or AIDC and/or unique product identifier.

As stated, UFind can be another feature of the system (See FIG. 8). This feature will deal with any product/service in any industry. From the consumer's perspective, UFind will be able search available inventory for product(s)/service(s) at stores/businesses/etc. by the consumer requesting the product(s)/service(s) via the consumer's last shopping list (previously scanned/created an image generation to be stored in a device), clicking on the products/services they would like to purchase from various categorized options, scanning in the AIDC and/or unique product identifier of the product(s)/service(s), scanning the product for image recognition or OCR, character recognition of the label, brand name, company name, product name, shape of product http://www.businessinsider.com/quiz-can-you-recognize-these-famous-products-stripped-from-their-branding-2012-6?op=1, unique product identifiers, entering in the product's information such as product name and product type or service provider's information and service provider's name and service type and then confirming product/service by identifying via a visual (of the AIDC and/or unique product identifier visual) or by description of the product/service. For products, the system can be programmed to ask if they would like the product delivered to an address or pick up at a location. The consumer has the option to expand the circumference of searchable area for nearby products to other stores, malls, business, etc. by a measured radius where the consumer is the center of the diameter and click on location of purchase via a map. The consumer can also search via a specific zip code or city other than consumer's current location for products. If the consumer chooses pick up at a location, the device will search the product by nearest driving distance, ranking and/or price depending on the consumer preference. The consumer will confirm where they would like to purchase the product and either purchase on device and put the product in for pickup status at the retailer or the consumer can go to the location and pickup and pay. If consumer goes to a location to pay, the consumer can be mapped directly to the product. If the consumer would like the product delivered, then the consumer searches product by ranking, shipping costs and/or price and pays for the product on device. This device will be able to search Nearby Products/service(s) (these products/service(s) would be near the location of the consumer's location recognized by GPS to search nearby stores, malls, business, etc.). Any device and/or any AIDC and/or unique product identifier can cross-reference any other device and/or AIDC and/or unique product identifier for the consumer's purchase stats on any product/service for the most recent/up-to-date and accurate information. If consumer's price of a product/service changes from a previous purchase, the device will ask if the consumer wants to record an average price, range price, less than the most recent price or enter a price to search for the product or service to find the price that's best for the consumer that's also the closest to the consumer via GPS or found online. For example, if one was searching for a detergent and were driving down a street UFind will direct you to the nearest detergent for sale. The system works the same for services as well. Moreover, as shown in FIG. 8, a consumer 100 can use a computer 500 to automatically search for various items using UFind. An AIDC could be used to find and recognize an item in a first step in a grocery store 502 or another item in step 2 from a department store 504.

The product(s) could be available at the nearby location based on the retailers' real-time inventory by the retailer scanning in the product's AIDC and/or unique product identifier once the product hits or is removed from the shelve/rack, etc., which would be able accessible via the retailer's current inventory stored in ProductCode. This will also show the consumer the exact location within the store, so if a consumer is in a store and can't find a product the system would be able to show the consumer via a map inside the store or the aisle number and location on the aisle, or department and location in department or section and location in section of a retailer's location that's identified by the device once the store is mapped. Certain AIDC and/or unique product identifier's will assist the consumer by directing the consumer to the exact location by GPS directions from the near frequency waves. Some other AIDC and/or unique product identifier will be able to be recognized in a store/business without searching the store/business for the product by scanning for the AIDC and/or unique product identifier in the store/business, so the device should be able to show the consumer the exact location of the product within a store/business. If for example, a consumer is in the front of a grocery store and wants to find the Breyer's Vanilla Ice Cream, the system would know the AIDC and/or unique product identifier associated with this product and scan the store for the product to notify the consumer where it's located by a GPS mapping of the store and even give directions or show where they are relative to the product in real-time to find the product in the store.

Services can be made available in real-time based on the service provider's schedule, which would be accessible via the service provider's calendar stored in the corresponding ServiceCode which will be updated in real-time based on the consumer's waiting, the current consumer being serviced and average wait time for each type of service to by cross-referenced to determine when a consumer interested in a service should arrive for a service. Average times will be derived by a consumer's schedule of when the appointments start and end for each type of service and taking an average within the types of service. For services, the system will ask if they would like the service for a location the consumer chooses or at the service provider's location depending on the service. The consumer can search nearby service(s) (these service(s) would be near the location of the consumer's location recognized by GPS to search nearby stores, malls, business, etc.) The consumer then has the option to expand the circumference of searchable area for nearby services to stores, malls, business, etc. by a measured radius where the consumer is the center of the diameter and click on location of purchase via a map. The consumer can also search via different zip code or city other than consumer's current location for products. If the consumer chooses pick up at a location, the system will search the product by nearest GPS, clicked or selected map location, ranking and/or price depending on the consumer preference. The consumer will confirm where they would like to purchase the service and either purchase service on device to reserve time slot of service provider or the consumer can go to the location with reserved time slot and pay on location. If consumer goes to location to pay, the consumer can be mapped to the service provider's location by GPS. If the consumer would like the service done at another location (depending on service) then the consumer searches service by ranking, service on site fees (if any) and/or price and pays for the service on device immediately or at time of service.

The system can also be programmed with Web recognition which functions to search the Service Provider's/Retailer's website for data/information needed on the company or products/services within the company. The system can also utilize location reference of the service provider/retailer to search on world wide web the company website and/or company name to find data and/or information on device searches the world wide web for the retailer/Service Provider data and/or information needed on the company and/or products/services. The system could also be able to search a product on the worldwide web via the AIDC and/or unique product identifier, company name, image generation, and/or product/service name. All data/information necessary for productcode, ucode and/or servicecode and/or any other type of type of database, software, associated website or AIDC and/or unique product identifier listed in this patent will be added to productcode, ucode, servicecode and/or any other type of database, software, associated website or AIDC and/or unique product identifier.

The various examples of uses of the system of the present disclosure are now presented (See also FIGS. 10-13). The consumer will have to consent to information being stored to utilize device. If the consumer would like their information transferred to another party, the consumer will have to consent to this as well. First the consumer needs to setup UHome and UHome Platform:

1. Connect UHome to the Television, Home Computer for a visual, utilize the Television with more than one image generation feature or any other device (listed in devices) to acquire an image.

2. Setup device with UCode technology in device to process data.

3. Turn on UHome

4. Place UHome Platform directly in front of UHome for improved scanning.

5. Consumer is asked to step on platform for scanning in a standard position and location given on the device's screen. The device will recognize if consumer is not standing correctly before it proceeds and instructs with visual proper position.

6. UHome will weigh person and then scan object while UHome Platform rotates the consumer on z-axis a 360 degrees.

UStore—This device is located in a retailer/service provider location like a mall, department store, individual store, etc. The reference to product In-Store can be a mall with many stores, a department store with many brands or/and a single retailer, etc.

In a step-by-step approach for a consumer to use UStore:

1. Consumer is asked to step on platform for scanning in a standard position and location given on the device's screen. The device will recognize if consumer is not standing correctly before it proceeds and instructs with visual proper position and location.

2. UStore rotates around consumer with a 360 degree rotation around the z-axis, while consumer stands still for scanning as the consumer will be the center of the z-axis.

3. Simultaneously a scale will weigh consumer

4. UStore will determine consumer's characteristics listed above along with their 3D image

5. UStore will ask if the consumer wants a 3D image of the consumer or to select an avatar from a variety of choices. The consumer can also switch from the consumer's 3D image to avatar at any time.

6. If consumer selects 3D image, then the 3D image of the consumer will be generated. If consumer selects avatar, then the 3D image of the avatar the consumer selects will be generated.

7. UStore will ask consumer to generate a UCode

8. UStore will ask consumer to generate a username and password for UCode

9. UStore will transfer characteristics along with 3D image of consumer or avatar to UCode

10. Consumer will be given the number to an available UStore Booth or UStore Booth with the shortest wait time

11. Consumer will enter UStore Booth number

12. Consumer will enter username and password in computer called UStore Booth

13. UStore Booth will ask Consumer to enter the consumer's name, email, gender and age to add to UCode

14. UStore Booth will ask if consumer would like Products In-store, Products Online (these are products associated with the In-Store that the consumer is located at currently, UAPP, UPP, UHome and UCopy)

Products In-Store (If consumer selects/says Products In-Store)—In another approach:

1. UStore Booth will ask consumer what product they are looking for in store with these Sections as options: Make-Up, Nails, Hair, Body, Apparel/Clothing, Accessories and Shoes

2. UStore Booth will ask consumer what product the consumer wants under the section including these subsections (For instance, the consumer selects/says Make-up as the Section and then Face for the Subsection) and Subsection including these Sub-subsections (For instance, the consumer selects/says Make-up as the Section and then Face for the Subsection and then Compacts for the Sub-subsection.)

4. Consumer will select/input what additive they would like i.e. SPF for tanning lotion, foundation, etc., glitter for pants, nail polish, or scents for lip sticks, etc. There are too many additive to mention, so these would be tagged by the consumer, so the device would search for these additives from a consumer preference perspective. These tags would be called additive tags. These would be catalogued under the consumer's username and password located in the consumer's UPP, UHome, UStore, UApp. The consumer will have the option to delete additive tags as the client's preferences change.

5. UStore Booth will cross reference the chosen product Sub-subsection or subsection (subsection only when there is no sub-subsection) with the consumer's Characteristics listed below or RTag, ProductCode and/or UCode (depending on the product the consumer's characteristics that are cross referenced would change Note: For instance, the coloring of a person's pants is not imperative on being a good fit for the consumer because it's not reflective on the person's skin except for the consumer's leg or tummy, but the consumer's age, gender, form/shape of body, measurements of the body would be cross referenced):

6. UStore Booth will search Nearby Products via UFind (these are products associated with the In-Store that the consumer is located at currently, but is unable to find the product in the actual In-Store location, which will be utilized on the UApp, UHome and UStore). The consumer has the option to expand the circumference of searchable area for nearby products to other stores outside of the In-Store by a measured radius where the consumer is the center of the diameter.

7. UStore Booth generates products that are cross-referenced via product, nearby product, additive tags and consumer's characteristics. RTag, ProductCode, ServiceCode and/or UCode will be utilized. Consumer will select or say product.

8. Consumer enters username and password or products are sent to a mobile device or printout.

9. If consumer chooses username and password, machine will ask if consumer would like to purchase item plus previously carted items, if any.

10. If yes or no, checkout or continue shopping. Product will be saved in cart.

11. If consumer sends products to mobile device or printout, UStore Booth sends a photo of product, price, barcode, RTag, ProductTag to mobile device or prints it out.

12. When photo of product, price, barcode, RTag, ProductTag are sent to mobile device or printout, consumer is asked if the consumer would like to checkout or continue shopping.

13. If checkout, the products will be saved under the consumer's username and password on all relevant mobile devices.

14. Consumer receives receipt with photo of product, price, barcode, RTag, ProductTag. Products purchased are saved under username and password and/or website if generated.

15. Personnel check receipt and items as the consumer leaves the store.

UPP (If consumer says/selects UPP). UPP cross-references UApp, UHome and URApp, RPP, URStore and USApp, SPP, USStore to get the most accurate information.

Nearby Products (these are products associated with the In-Store that the consumer is located at currently, but is unable to find the product in the actual In-Store location, which will be utilized on the UApp, UHome and UStore).

1. Machine will transfer data/preferences previously determined by UStore to UPP.

2. UPP will generate all the same information or sequences/steps mentioned in Products In-Store, but now with UPP the consumer can reference any company, any product type/category or product associated with UPP also when generating UPP there is a website associated with the consumer relating to the UPP, so the consumer's website will be printed on the receipt as well.

3. UPP includes all companies including retailer and/or service providers that deal with Make-Up, Nails, Hair, Body, Apparel/Clothing, Accessories and Shoes.

4. UPP includes all RTags, UCode, ProductCode, ServiceCodes associated with purchase.

UApp (If consumer says/selects UApp). UApp cross-references UPP, UHome and URApp, RPP, URStore and USApp, SPP, USStore to get the most accurate information for products, services and consumers.

Nearby Products (these are products associated with the In-Store that the consumer is located at currently, but is unable to find the product in the actual In-Store location, which will be utilized on the UApp, UHome and UStore).

1. Machine will transfer data/preferences previously determined by UStore to UApp on mobile device.

2. UApp will generate all the same information or sequences/steps mentioned in Products In-Store, but now with UApp the consumer can reference any company, any product type/category or product associated with UApp.

3. UApp includes all companies including retailer and/or service providers that deal with Make-Up, Nails, Hair, Body, Apparel/Clothing, Accessories and Shoes.

4. UApp includes all RTags, UCode, ProductCode, ServiceCodes associated with purchase.

UHome (If consumer says/selects UHome). UHome cross-references UPP, UApp and URApp, RPP, URStore and USApp, SPP, USStore to get the most accurate information for products, services and consumers.

Nearby Products (these are products associated with the In-Store that the consumer is located at currently, but is unable to find the product in the actual In-Store location, which will be utilized on the UApp, UPP and UStore)

1. Machine will transfer data/preferences previously determined by UStore to UHome on mobile device.

2. UHome will generate all the same information or sequences/steps mentioned in Products In-Store, but now with UHome the consumer can reference any company, any product type/category or product associated with UHome.

3. UHome includes all companies including retailer and/or service providers that deal with Make-Up, Nails, Hair, Body, Apparel/Clothing, Accessories and Shoes.

4. UHome includes all RTags, UCode, ProductCode, ServiceCodes associated with purchase.

UCopy (If consumer says/selects UCopy). UCopy is utilized to provide the consumer a printout/hardcopy, email, fax.

1. Machine will transfer data/preferences previously determined by UStore to UCopy.

2. UCopy will be able to access all the same information or sequence/steps mentioned in Products In-Store and/or UStore Booth, but now with UCopy the consumer can obtain a printout/hardcopy, email, fax of all the information gathered by UStore and/or UStore Booth.

3. UCopy includes all companies and purchases referenced during UStore and/or UStore Booth session Make-Up, Nails, Hair, Body, Apparel/Clothing, Accessories and Shoes.

4. UCopy includes RSUTags, UCode, ProductCode, ServiceCodes, USpaceLookup, USearch associated with purchase.

In another approach, U stands for an automated personalization consumer activity for an individual. The system for personalized shopping for the individual U can be stationary or mobile devices. These devices can input information and/or output information. Devices for Make-Up, Nails, Hair, Body, Apparel/Clothing, Accessories and Shoes industry would be personalized to the consumer. For the industries of Makeup, nails, hair, body, clothing, shoes, accessories the characteristics that will create consumer personalization are StyleCode, OccasionCode, ColorCode, ShapeCode, DimensionMeasurementCode, SurfaceMaterialCode, PatternCode, WeightCode, HeightCode, AgeCode, GenderCode and AdditiveCode. These will be further narrowed down to “It's YOU”/Match for product(s) and/or service(s) are Match Characteristics, Physical Characteristics of the consumer, Preference Characteristics of the consumer for products and services. These characteristics will be evaluated from consumer inputting data, social media sites, scale, consumer profiling, scanning or inputting AIDC and/or unique product identifier, dimension measurement, image generation, algorithms associating input(s) from consumer, consumer's calendar and algorithms from data derived from image generation. These characteristics can be categorized individually, grouped, cross-referenced for better analysis of the consumer. In some instances, not all of these will be utilized to cross-reference as shown below.

AgeCode. Physical Characteristic: Age: This will also narrow down what products/services are shown based on the consumer's age: 7-year-old boy is not going to wear a 47 year olds suit. The items will only show what they would be interested in based on the consumer's age.

GenderCode. Physical Characteristic: Gender: If they are evaluated to be a male, then the device will include Categories with only masculine products/services and if female vice versa, if applicable.

HeightCode. Physical Characteristic: Height: If a consumer has changed in weight or height, the device will be able to analyze the consumer's current weight and height and if there's not a drastic difference say of more than a 5% change, the device will be able to adjust dimensionmeasurementCode to determine new sizes, measurements, dimensions for the difference for a period of time until they need reanalysis.

WeightCode. Physical Characteristic: Weight: If a consumer has changed in weight or height, the device will be able to analyze the consumer's current weight and height and if there's not a drastic difference say of more than a 5% change, the device will be able to adjust dimension measurement Code to determine new sizes, measurements, dimensions for the difference for a period of time until they need reanalysis.

StyleCode. Style preference(s) and Style Matches for body, face, facial features, hair and nails: If consumer is evaluated to have a certain style(s), then the device will include Categories with only this/these style(s) preferences for products/services.

Some Style like bell bottoms are not a match to a body shape like a banana, so this would be an example of a none match to a consumer's body shape, whereas bell bottoms would be great on a pear shape.

OccasionCode. Occasion preference(s) and match(es) for body, face, facial features, hair and nails An occasion preference would be a preference on holidays to celebrate, events, birthdays, etc. based on the consumer's calendar or social media site. Occasion matches would be the certain product(s)/service(s) that match the occasion. For instance you wouldn't wear a bathing suit to a formal gathering, but you would wear a dark colored formal gown that goes all the way to the floor.

SurfaceMaterial Code. Physical Characteristics: Texture of body, face, facial features, hair and nails. Physical Characteristics: Surface of body, face, facial features, hair and nails. Surface material preferences of body, face, facial features, hair and nails (fabrics and other materials). Surface material match(es) of body face, facial features, hair and nails. Texture material preferences of body, face, facial features, hair and nails (lotions and other materials). Texture material match(es) of body, face, facial features, hair and nails. Physical Characteristics: Texture material of body, face, facial features, hair and nails would be skin, hair, eyes and nails.

An example of a texture type would be a skin type. E.g. skin type (as oily, normal or dry. Sensitive or Non-Sensitive. Wrinkled or non-wrinkled.) So an oily, sensitive, wrinkled skin type would be an OSW.

E.g. hair shape: Straight, Wavy, Large curls, Medium Curls or Small Curls. Treated or Not-treated (with color or perm/Brazilian blow out/etc. chemicals.) Oily, Normal or Dry. Hair Shaft Shape: Thin, Average or Heavy. So a consumer with Medium curls, treated, normal, thin would be a hair type of MTNT.

Physical Characteristics: Surface material of body, face, facial features, hair and nails would be skin, hair, eyes and nails. Surface material preferences of body, face, facial features, hair and nails (The consumer could have preferences in certain products/services for the body, face, facial features, hair and nails such fabrics like leather, cotton, suede, etc.). Surface material match(es) of body face, facial features, hair and nails. (The consumer could have matches in certain products/services for the body, face, facial features, hair and nails such fabrics like leather, cotton, suede, etc. as their skin might be allergic to material) If they prefer this material the software would know to use the layering technique and put fabrics in between their skin and the allergic fabric.)

Texture material preferences of body, face, facial features, hair and nails (The consumer could have preferences in certain products/services affecting the texture of the body, face, facial features, hair and nails such lotions, perfumes, shampoos, conditioners and other materials). Texture material match(es) would be evaluated based on the types of skin, hair, eyes and nails of the body, face, facial features, hair and nails. E.g. skin type (as oily, normal or dry. Sensitive or Non-Sensitive. Wrinkled or non-wrinkled.) So an oily, sensitive, wrinkled skin type would be an OSW. So there would be certain products/services that match this skin type and others that don't match. Continuing with this example, the additives/ingredients in the product would be checked to see if they matched.

DimensionMeasurementCode. Physical Characteristics: Measurements of the body, face, facial features, hair and nails. Physical Characteristics: Sizes of the body, face, facial features, hair and nails (for clothing, shoes, hats, etc.). Physical Characteristics: 2D and 3D dimensions of body, face, facial features, hair and nails. Devices will use image generation or dimensional measurement to derive measurement, shape, size and form the related 2D or 3D image (listed under Dimensionmeasurementcode as Physical Characteristics: 2D and 3D dimensions of body, face, facial features, hair and nails). If system only has one camera, dimension measurement will be utilized or image generation will be utilized if more than one camera.

The system will utilize dimension measurement or image generation along with hair recognition for recognizing a consumer's hair and notify the consumer of the consumer's hair length.

If female, the dimension measurement will have readily accessible measurements of consumer's height, waist, bust, waist, hips, shoe, head and inseam. If male, the dimension measurement or image generation will have readily accessible measurements of consumer's height, chest, waist, hips, neck/collar, head and inseam. If dimension measurement or image generation is not utilized, the consumer will have to input measurements.

Height: Measurement from the top of the head to the bottom of feet or floor

Waist: Measurement circumference at the narrowest part

Chest/Bust: Measurement from under the arms and around chest/bust

Hips: Measurement at the fullest point, standing with feet together

Inseam: Measurement from the ankle to the highest point of the inner thigh

Neck/Collar: Measurement around neck or collar where shirt neck/collar fits

Shoe: Measurement from the heel to the toe

Head: Measurement from just above the eyebrow around the head

ColorCode. Physical Characteristics: Skin Coloring of body, face, facial features, hair and nails via image generation of consumer. Color Preference(s) for body, face, facial features, hair and nails. Color Match(es) for body, face, facial features, hair and nails checking consumer's coloring eye, hair, skin along with possibly checking vein color or hair, skin and eye color to determine undertone to derive matching colors. Device will have another screen for preference colors which will be linked to the consumer's ColorCode. The Device will allow them to either take an image of the consumer's preference: likes and dislikes of colors to save or the consumer can select the consumer's preference: likes and dislikes of colors from a color wheel (FIGS. 14-16). These colors will be added and or cross-referenced with the colors the App has determined are the best for the consumer, if the consumer has color preference.

As the image generation might obscure their skin complexion and facial feature colors, the subject will have the option to adjust the colors of the consumer's skin, eye, hair and lip coloring.

Skin Shades or Tints. These will be utilized to derive the complementary, analogous or tertiary colors (See FIGS. 14 and 15). Consumer's skin coloring will be given via a skin shade or tint value of light, light-medium, medium-light, medium, medium-dark, dark-medium or dark based on the Subject's L value. The range of each shade or tint is 14.2857143 E.g. Light—L is range from 100 to 85, Lightest in complexion.

The system would determine the consumer's primary undertone complementary color, primary undertone analogous complementary colors, primary underhue complementary color, primary underhue analogous complementary colors, for their skin, hair, eyes and lips from the consumer's face image (See again FIGS. 14-16). This can also be done with the hue as well. The undertone, underhue and hue will be computed via an algorithm. The primary undertone complementary color will determine the color of beauty product(s)/service(s) that would be complimentary to their undertone. The primary undertone analogous complementary colors will determine the colors near the primary undertone complimentary color would be their secondary complimentary undertone colors, which would determine the Consumer's tone colors for beauty product(s)/service(s). The primary underhue complementary color will determine the coloring of beauty product(s)/service(s) that would be complementary to their underhue. The primary underhue analogous complementary colors will determine the colors near the primary underhue complimentary color would be their secondary complimentary underhue colors, which would determine the Consumer's pure colors for beauty product(s)/service(s). The hue quantities that make up the consumer's coloring will determine the consumer's best hue via a calculation or algorithm of the consumer's coloring (eye, hair, skin), skin or vein.

Skin Undertone has grey and we have removed the gray to acquire the underhue. The underhue is without value (white and black) or saturation (gray). Hue (Pure Colors—on the outer part of the color wheel) and Undertone Chart (Tones are added amount of gray to the hue).

ShapeCode. Physical Characteristics: Shape of body, face, facial features, hair and nails. Shape Match(es) for body, face, facial features, hair and nails. Shape Preference(s) for body, face, facial features, hair and nails checking consumer's measurements or 3D form to derive consumer's shape. The consumer preferences of what parts of the consumer's body, face, facial features the consumer has preferences on liking or disliking will be stored under ShapeCode. The system will have another screen for preferred or not preferred facial features/body parts that will be linked to the ShapeCode. If it shows the consumer's full body image, then the consumer can click on the parts the consumer prefers on one screen and the next screen they can click on parts the consumer does not prefer to show. If the consumer does not have an image saved, the system will ask the user to say the body parts or select from an option of body parts/face facial features the consumer prefers or does not prefer.

The system will utilize dimension measurement or image generation along with hair recognition for recognizing a consumer's hair and notify the consumer of their individual shapes or hair shaft size. Hair Shapes: Straight, Wavy, Large curls, Medium Curls or Small Curls. Hair Shaft Shape Thin, Average or Heavy. The device will utilize dimension measurement or image generation along with face recognition and facial feature recognition for each shape and notify the consumer of their individual shapes. Face Shapes: Heart, Oval, Long, Round, Square, Pear or Oblong, Oval, Round, Rectangular, Square, Triangle, Diamond, Inverted Triangle, Heart. Facial Features Lip shapes—A. Full Lips, Wide Lips, Round Lips, Thin Lips B. Bow Shaped Lips/Heart Shaped Lips, Downward Turned Lips. E.g. Full Bow Shaped Lips or Thin Downward Turned Lips. Eye Shapes—A. Almond, Oval or Round B. Size—Small, Big, Standard C. Eye Width—Close Set, Wide Set, Standard Set D. Eye Positioning—Downturned, Upturned, Standard (Since the camera is only 2 dimensional with one camera on mobile apps then Eye Depth can't be computed as it deals with the 3^{rd} dimension.) E. Eye Depth—Deep Set, Prominent, Standard Nose Shapes—Turned-up or celestial nose, snub nose, Greek nose, aquiline nose, Roman nose, broad nose, bulbous nose, fleshy nose, hawk nose, straight-long-pointy nose-smooth nose-, Bumpy nose, Sturdy nose, Round nose, Nixon Nose, Flat Nose. Cheek Shapes—Round, Flat, Long, Short, pointy. Forehead Shapes—Round/sloped, Flat, Long, Short, pointy. Chin Shapes—Round, Flat, Long, Short, pointy. Eyebrow Shapes—Round, Angled, Soft Angled, Curved, Flat.

System will give the consumer their Face Shape, Lip Shape, Nose Shape and Eye Shape and facial feature shapes.

System will suggest certain beauty products/services that would match the consumer's face shapes and facial feature's shapes. Body Shapes: Pear, Apple, Strawberry, Hourglass, Banana/Rectangle.

Device will determine the consumer's body shape of Pear, Apple, Strawberry, Hourglass and Banana/Rectangle. Device will suggest certain beauty products/services that would match the consumer's body shape. Device will give the consumer the option to take another image generation or enter measurements.

PatternCode. Pattern matches location of body, face, facial features, hair and nails. The match finds the location a pattern should be on the body based on the consumer's shape. A horizontal pattern should be on the lower half like pants of a strawberry shaped body. A vertical pattern should be on the bottom half like a skirt on a pear shape.

Pattern Preferences location of body, face, facial features, hair and nails. Ex: A consumer might have a preference in horizontal striped shirt, but the consumer's body is a strawberry, which is not a match.

AdditiveCode. Additive match(es) of body, face, facial features, hair and nails. Additive preference(s) of body, face, facial features, hair and nails. Additive matches would be determined by Skin texture analysis will be utilized to determine the skin type of a consumer's face to determine what additives/ingredients are a match by either scanning or capturing an image of the consumer's face.

Or additive matches would be determined by scanning in product(s)' AIDC and/or unique product identifier or ingredients list on packaging that the consumer says works well with the consumer's and AIDC and/or unique product identifier or ingredients list on packaging of products that do not work for consumer to determine what ingredients/additives are a match to the consumer to determine other product matches.

If not feasible, the app will ask the subject a few questions with visual images to depict type for consumer to determine skin type (as oily, normal or dry. Sensitive or Non-Sensitive. Wrinkled or non-wrinkled.) So an oily, sensitive, wrinkled skin type would be an OSW.

Skin texture analysis. Another emerging trend uses the visual details of the skin, as captured in standard digital or scanned images. This technique, called skin texture analysis, turns the unique lines, patterns, and spots apparent in a person's skin into a mathematical space.

Consumer will select/input what additive/ingredient they would like i.e. SPF for tanning lotion, foundation, etc., glitter for pants, nail polish, or scents for lip sticks, etc. There are too many additive to mention, so these would be tagged by the consumer, so the device would search for these additives from a consumer preference perspective. These tags would be called additive tags. These would be catalogued under the consumer's username and password located in the consumer's device. The consumer will have the option to delete additive tags as the client's preferences change.

Device will give the option to Adjust/Change/Retake any image generation or dimensional measurement image previously evaluated. A device will be able to add to each characteristic until 100% complete. This section will also allow Consumer to utilize their consumer's UCode to find the consumer's StyleCode, OccasionCode, ColorCode, ShapeCode, DimensionMeasurementCode, SurfaceMaterialCode, PatternCode, WeightCode, HeightCode, AgeCode, GenderCode and AdditiveCode and then click on parts of the Consumer to determine the consumer's personalized characteristic. For instance, if they clicked on ShapeCode and clicked on the consumer's body and the consumer had a pear shaped body the ShapeCode would say: ShapeCode. Shape of body: Pear Shaped Body. Shape Match(es) for body: (Product(s)/Service Match(es) for body) product ex: bell bottom pants, A-line dress, empire waist dress, etc. (to even out the bottom with the rest of your bottom half). Shape Preference(s) for body: (Product(s)/Service Preference(s) for body) Consumer likes skinny jeans, etc. and dislikes bell bottoms etc.

The device would tell consumer their attributes for Shape Match(es) for body and Shape Preference(s) for body above. Then show on the consumer's image how to wear each attribute (unless it was a dislike in preferences, then it won't be shown to consumer) with other attributes of other categories cross-referenced.

Characteristic attribute preferences will be analyzed by consumer profiling by finding patterns dealing with the consumer's different characteristic attributes previous purchases, wish lists, etc. in StyleCode, OccasionCode, ColorCode, ShapeCode, DimensionMeasurementCode, SurfaceMaterialCode, PatternCode, WeightCode, HeightCode and AdditiveCode. Examples of Characteristic Attributes in the above example are Pear Shaped Body, Bell Bottom pants, A-line dress, empire waist dress and skinny jeans.

Next is presented an example of cross-referencing ColorCode and ShapeCode with the previous example of ShapeCode. ShapeCode and ColorCode. Skin Coloring and Shape of body: Pear Shaped and Medium Skin with Yellow Undertone. Color and Shape Match(es) for body: Bell bottoms with dark color, A-line dress with purple upper part of dress and dark color lower part of dress (a purple that will go well with the yellow undertone) and empire waist dress with a blue upper and dark color lower (a purple that will go well with the yellow undertone) (dark color on each product will less accentuate lower half).

Color and Shape Preference(s) for body—skinny jeans for a pear shaped body is not a match. The device will suggest with a dark wash near upper part of bottom and a lighter wash near lower part of jean or will ask if it would like to layer another product since this preference is not a match. If layering could put dark skinny jeans with light knee high boots. The layering option given would be the light knee high boots.

The system utilizes these technologies: 3 Dimensional Recognition, face recognition and same technology to recognize the body, facial features, hair and nails, skin texture analysis, voice recognition, touch screen and/or kinectic.

The system will ask consumer to take an image generation from a frontal view and side view of face and body to determine consumer's characteristics. For input, the device will ask the consumer a few questions with visual images to determine ex: hair shape: Straight, Wavy, Large curls, Medium Curls or Small Curls. Treated or Not-treated (with color or perm/Brazilian blow out/etc. chemicals.) Oily, Normal or Dry. Hair Shaft Shape: Thin, Average or Heavy. The system will derive length of hair from image. The system will derive hair color from photo. So a consumer with Medium curls, treated, normal, thin would be a hair type of MTNT.

The system will correlate the consumer with a username and password/RSUTag/UCode that will save the consumer's data to be scanned, transferred, stored into other devices to show consumer what products/services in the market would look best on the consumer based on the consumer's characteristics.

The system will have the option to share all the product(s)/Service(s) that match/“It Fits You” and the consumer's characteristics and Retailer/Service Provider Favorites with other similar consumers, friends and family by image generation, transferring data, storing AIDC and/or unique product identifier/RSUTag/UCode associated with consumer, video chat, email, instant messaging, text, send images on a social media platform or other software.

Match means the product/service works with the consumer's physical characteristics. “It Fits You” means it works with your preferences. If consumer has setup a user personal profile website, software, AIDC and/or unique product identifier relating to the consumer, RSUTag or UCode, the device will allow the consumer to utilize a feature called “Go Shopping” on via any device or technology.

U Devices Utilizes each of the following functions:
Go Shopping
Tutorials
Align Product(s) and Service(s)
Products/Services Purchased/Wish List
Retailer/Service Provider Favorites
Consumer Favorites
Trends
Retailer/Service Provider Restrictions
USpaceLookup

The options of these systems that can be chosen are Trends (The current season's top fashions), Go Shopping, Stats (Includes consumer characteristics and consumer stats), Categories/Product Types (Makeup, nails, hair, body, clothing, shoes, accessories), Services (Makeup, nails, hair, body, clothing, shoes, accessories) sign into another device, Tutorials, Products/Services Purchased/Wish List, Retailer/Service Provider Favorites, Retailer/Service Provider Restrictions, Consumer Favorites and USpaceLookup.

The characteristics gathered from consumer will create UCode associated with username and password or other AIDC and/or unique product identifier identifications.

Online Store. On Computer, App, Notebook, Tablet, Cellphone with Android/IPhone, In-Home Console Scanner, In-Store/Mall Full-Body Product Scanner, etc. or work with any monitor with the software and a camera for dimension measurement. (Utilized in any product/service not merely Make-Up, Nails, Hair, Body, Apparel/Clothing, Accessories, Shoes and/or Beauty products and services). Online Store Sections—Make-Up, Nails, Hair, Body, Apparel/Clothing, Accessories and Shoes.

In the following categories/product types of Make-Up, Nails, Hair, Body, Apparel/Clothing, Accessories and Shoes, if the device has a stored 3D image from the device or a 2D image from the device these images will be utilized to show the consumer what they will look like in the product selected. The consumer can continue to select/delete products to get a final look. If the consumer has a 3D image from device the consumer will have the option to rotate 360 degrees on z-axis the 3D image to view different angles of what they look like in various items. If the consumer has a 2D image, then the consumer will view a 2D image of the parts the consumer would like to view. This will utilize “It Fits You/Match” and layering. For instance, the consumer takes an image of their face and their body, so if the consumer would like to see how a skirt looked on their body they would click on the skirt and the computer program would put the skirt on their 2D/3D image body, which would include the consumer's face as it's part of the body. If they also wanted to see what a lipstick would look like on their face the computer program would automatically reference the 2D/3D image of the face and place the lipstick on the consumer's lips. They could also select items and place them on their body like a skirt, shirt and shoes to view the overall look. The consumer could also place makeup on their face by varying thicknesses of each makeup type to see their overall makeup look. The product(s) that show(s) up on the consumer's online website will “It Fits You”/Match on the consumer by comparing the consumer's StyleCode, OccasionCode, ColorCode, ShapeCode, Dimension/MeasurementCode, SurfaceMaterialCode, PatternCode, AgeCode, GenderCode, WeightCode, HeightCode and/or AdditiveCode to the product's AgeCode, GenderCode, StyleCode, OccasionCode, ColorCode, ShapeCode, Dimension/MeasurementCode, SurfaceMaterialCode, PatternCode, WeightCode, HeightCode and/or AdditiveCode to come up with what's called a “It Fits You”/Match. A Match is designed to align the consumer with the best product(s)/service(s). “It Fits You” is designed to align the consumer with the consumer's preference in product(s)/service(s). If a consumer's “It Fits You” is not a match for any of the consumer's physical characteristics, the device will utilize layering of product(s)/service(s) to make the product(s)/service(s) a better match.

Will determine any color via tone (See FIGS. 14-16), undertone and/or hue for higher accuracy. Below are merely examples of the different products in beauty and how the physical characteristics will be compared to find a match. As there are too many to list, few for example purposes are presented. In the Beauty Industry, examples of how the system works with the product to determine characteristics is next described.

Make-up. Face—Blush, Bronzers, Compacts, Concealers, Foundations, Powders, Primers (device will analyze the consumer's face skin color via skintone, undertone, hue for higher accuracy). Eyes—Brows, Eyeliners, Eye shadows, Mascara (device will analyze the consumer's eye color and skincolor for higher accuracy) (device will find Eye Shadows based on complementary colors, analogous complementary colors for the consumer's skin color, hair color and eye color) (Consumer will be able to increase or decrease a shade to the shade desired). Lips—Lip Gloss, Lip Liners, Lipsticks (device will analyze the consumer's lip color for higher accuracy) (device will find Lip Colors based on complementary colors for the consumer's skin color, hair color, eye color and lip color) (Consumer will be able to increase or decrease a shade to the shade desired).

Nails. Nail Polish—(device will analyze the consumer's skin color for higher accuracy) (device will find Nail Polish Colors and Glitters based on complementary colors for the consumer's skin color).

Hair. Hair Color—Platinum, Gray, Blonde, Dirty Blonde, Strawberry Blonde, Red, Dark Red, Brown, Dark Brown, Black (Color given will be these generic colors not to confuse consumer, but the device will analyze the consumer's hair color for higher accuracy).

Body. Tanning Lotions—(device will analyze the consumer's skin color and skin tone for higher accuracy) (device will find Tanning Lotions based on the consumer's skin color and skin tone) (Consumer will be able to increase or decrease a shade to the shade desired starting from the consumer's skin color as the lightest).

Body Bronzers—(system will analyze the consumer's skin color and skin tone for higher accuracy) (device will find Body Bronzers based on the consumer's skin color) (Consumer will be able to increase or decrease a shade to the shade desired starting from the consumer's skin color as the lightest).

Tattoo Concealer—(system will analyze the consumer's skin color and skin tone for higher accuracy) (device will find Tattoo Concealer based on the consumer's skin color).

Apparel—(system will analyze the consumer's skin color and skin tone for higher accuracy) (system will analyze the consumer's body shape for higher accuracy) (system will find Apparel based on the consumer's skin color to find complementary colors and give the consumer hues of the consumer's complementary colors, if apparel is near face) (Consumer will be able to increase or decrease a shade to the shade desired within the consumer's complementary colors after selecting a color hue) (system will find Apparel based on the consumer's body shape) (system will analyze the consumer's dimension measurement to determine size). Dresses—Casual, Club, Evening, Work. Tops—Basics, Knits, Blouses, Graphic Tees and Tanks, Camis and Tanks Sweaters and Cardigans—Short Sleeve, Long Sleeve, Cardigans, Ponchos and Shawls. Outerwear—Leather Jackets, Jackets, Blazers, Vests, Coats, Athletic. Bottoms—Jeans, Pants, Shorts, Skirts, Leggings. Activewear—Tops, Sports Bras, Pants, Shorts. Lingerie—Bras, Corsets, Thongs, Boyshorts, Nightie, Lingerie Sets. Underwear—Boxers, Briefs. Swim—One Piece, Bikini Suits/Tux—Blazer, Vests, Dress Pants, Dress Shirts.

Accessories—(system will analyze the consumer's skin color and skin tone for higher accuracy) (system will analyze the consumer's body shape for higher accuracy, if accessory is on/near the body) (system will analyze the consumer's face shape for higher accuracy, if accessory is on/near the face) (system will find Apparel based on the consumer's skin color and skin tone complementary colors and give the consumer hues of the consumer's complementary colors, if accessory is near face) (Consumer will be able to increase or decrease a shade to the shade desired within the consumer's complementary colors after selecting a color hue) system will find Accessories based on the consumer's body shape or face shape) (device will analyze the consumer's measurements to determine size, if necessary).

Jewelry—Necklaces, Earrings, Bracelets, Rings, Watches. Bags and Wallets—Shoulder Bags, Hobos, Totes, Clutches, Wallets.

Hair Accessories. Hats (system will determine belt size) (system will determine match/“It Fits You” colors).

Belts (system will determine belt size, where belt should be placed for shape).

Eyewear—Sunglasses, Readers, etc. (system will use face shape to determine eye glasses match shape).

Shoes—(system will base the measurement of the consumer's feet scanned on the platform below the Consumer) (system will ask consumer if the consumer would like shoes based on the consumer's complementary colors or the consumer's skin color, eye color or hair color or neither).

Platform with console or other device. Another type of system will derive dimension, measurement, shape, size for DimensionMeasurementCode and ShapeCode, derive the consumer's weight for WeightCode, Height for HeightCode, color for ColorCode and surface material and texture for SurfaceMaterialCode. This device will be able to scan the parts of the body including the face and facial features. When the device scans the consumer, the platform under the consumer will turn slowly to give the device a 360 degree image to align the pixels to create a 3D image or 2D image with DimensionMeasurementCode, ShapeCode, WeightCode, HeightCode, ColorCode, SurfaceMaterialCode. The platform will weigh the consumer for WeightCode. The other physical characteristics will be derived by the consumer inputting physical characteristics or scanning in the consumer's Driver's License to create the total UCode for physical characteristics. Consumer will also be able to alter characteristics or stats derived from DL, if they are not correct. Consumer will have the option of scanning DL for more stats and characteristics or credit cards for future purchases or smartcard or an AIDC and/or unique product identifier that has stats, characteristics or purchase information. This device will connect wire/wirelessly to an output device like a monitor to give the consumer a visual and communicate or the device will be an input/output device, so there will be no reason to connect via wire/wirelessly with an output device. The device will have the capability to transfer all physical characteristics and matches of StyleCode, OccasionCode, ColorCode, ShapeCode, DimensionMeasurementCode, SurfaceMaterialCode, PatternCode, WeightCode, HeightCode, AgeCode, GenderCode and AdditiveCode to UCode wire/wirelessly. On the output device the consumer will be able to rotate the 3D image or utilize dimensional movement to move the virtual consumer in the way the actual consumer moves. Instead of utilizing the consumer's virtual image with the characteristics of the consumer, the consumer can select an avatar with similar characteristics and the consumer's characteristics will be stored via UCode for purchases of products/services. This device will also be able to generate Trends (The current season's top fashions), Go Shopping, Stats (Includes consumer characteristics and consumer stats), Categories/Product Types (Makeup, nails, hair, body, clothing, shoes, accessories), Services (Makeup, nails, hair, body, clothing, shoes, accessories) sign into another device, Tutorials, Products/Services Purchased/Wish List, Retailer/Service Provider Favorites, Retailer/Service Provider Restrictions, Consumer Favorites and USpaceLookup or any cross-referencing utilized, as previously mentioned.

Any device should be able to create a hologram of a virtual consumer of the consumer to try-on beauty product(s)/service(s).

Full Body Scanner. Another type of system that will gather all physical characteristics would be another full body scanner (See FIG. 3). The device would around consumer with a 360 degree rotation around the z-axis, while consumer stands still for scanning as the consumer will be the center of the z-axis in standard position and location and scale will weigh consumer that will create a 3D image or 2D image. Consumer will have the option of scanning DL for more stats and characteristics or credit cards for future purchases or smartcard or an AIDC and/or unique product identifier that has stats, characteristics or purchase information. The system will determine the consumer's StyleCode, OccasionCode, ColorCode, ShapeCode, DimensionMeasurementCode, SurfaceMaterialCode, PatternCode, WeightCode, HeightCode, AgeCode, GenderCode and AdditiveCode and have the capability to transfer all physical characteristics and matches of StyleCode, OccasionCode, ColorCode, ShapeCode, DimensionMeasurementCode, SurfaceMaterialCode, PatternCode, WeightCode, HeightCode, AgeCode, GenderCode and AdditiveCode to UCode wire/wirelessly. On the output device the consumer will be able to rotate the 3D image or utilize dimensional movement to move the virtual consumer in the way the actual consumer moves. Instead of utilizing the consumer's virtual image with the characteristics of the consumer, the consumer can select an avatar with similar characteristics and the consumer's characteristics will be stored via UCode for purchases of products/services. This device will also be able to generate Trends (The current season's top fashions), Go Shopping, Stats (Includes consumer characteristics and consumer stats), Categories/Product Types (Makeup, nails, hair, body, clothing, shoes, accessories), Services (Makeup, nails, hair, body, clothing, shoes, accessories) sign into another device, Tutorials, Products/Services Purchased/Wish List, Retailer/Service Provider Favorites, Retailer/Service Provider Restrictions, Consumer Favorites and USpaceLookup or any cross-referencing utilized, as previously mentioned.

All systems will have the capability of shopping for product(s)/service(s) In-Store or Online or via the product's hologram.

Any system will be able to search Nearby Products/service(s) (these products/service(s) would be near the location of the consumer recognized by GPS to search nearby stores, malls, business, etc. The product(s) would be available at the nearby location based on the retailers' real-time inventory, which would be able accessible via the retailer's current inventory stored in the corresponding ProductCode. The service would be available in real-time based on the service provider's schedule, which would be accessible via the service provider's calendar stored in the corresponding ServiceCode. The consumer has the option to expand the circumference of searchable area for nearby products to other stores, malls, business, etc. by a measured radius where the consumer is the center of the diameter. Some AIDCs and/or unique product identifiers will be able to be recognized in a store/business without searching the store/business for the product by scanning for the AIDC and/or unique product identifier in the store/business, so the device should be able to show the consumer the exact location of the product within a store/business. Let's say a consumer is in the front of a grocery store and wants to find the Breyer's Vanilla Ice Cream, the technology would know the AIDC and/or unique product identifier associated with this product and scan the store for the product to notify the consumer where it's located by a GPS mapping of the store and even give directions or show where they are relative to the product in real-time to find the product in the store.

Consumer will be able to save products or services on the consumer's wish list or cart on any device. Consumer will be able to send/print or generate a receipt of products and/or services and consumer will be able to send/print data of a consumer to any device through video chat, email, instant messaging, text by sending images, descriptions of products, associated ProductCode, USearch, AIDC and/or unique product identifier or RSUTag to any system. Any system/technology will cross-references any device/technology to get the most accurate and up-to-date information of data and characteristics.

For a retailer, the following is a description of one approach. As before, these systems will be stationary or mobile devices and will input information and/or output information.

Below shows how the products in the Make-Up, Nails, Hair, Body, Apparel/Clothing, Accessories and Shoes industry would be personalized to the retailer. This will be a system for distribution center, retail store, company office, warehouse, etc. of a company that sells Make-Up, Nails, Hair, Body, Apparel/Clothing, Accessories and/or Shoes. Distribution center, retail store, company office, warehouse, etc. of a company will be referred to as retailer(s)/company type in this section.

The data derived from ServiceCode, ProductCode and UCode will keep the consumer, retailers and service providers consistent to provide the consumer with the best service and/or retail experience.

Any system will have the ability to scan, enter or transfer data from a product AIDC and/or unique product identifier/RSUTag/ProductCode associated with retailer.

For the industries of Makeup, nails, hair, body, clothing, shoes, accessories the characteristics that will create product personalization are StyleCode, OccasionCode, ColorCode, ShapeCode, DimensionMeasurementCode, SurfaceMaterialCode, PatternCode, WeightCode, HeightCode, AgeCode, GenderCode and AdditiveCode, while all are associated with UCode to be cross-referenced some characteristics will be associated with the ProductCode to cross-referenced. These will be further narrowed down to “It's YOU”/Match for product(s) that Match Characteristics of the retailer's product's Physical Characteristics. These characteristics will be evaluated from retailer inputting data, social media sites, scale, consumer profiling, scanning or inputting AIDC and/or unique product identifier, dimension measurement, image generation, algorithms associating input(s) from retailer and algorithms from data derived from image generation. These characteristics can be categorized individually, grouped, cross-referenced for better analysis of the product.

This system will utilize product recognition with the characteristics below and voice recognition and touchscreen technology or kinetic technology to make selections. Product recognition—will determine the exact product.

The characteristics for a retailer's products are the same i.e. AgeCode, GenderCode, StyleCode, OccasionCode, ColorCode, ShapeCode, PatternCode, DimensionMeasurementCode, SurfaceMaterialCode, AdditiveCode, except instead of a consumer characteristic will deal with the product characteristic and the retailer is the consumer.

AgeCode. Physical Characteristic: Age (Retailer inputs product age then device derives age/derived from retailer's website).

GenderCode. Physical Characteristic: Gender (Retailer inputs product age then device derives age/derived from retailer's website).

StyleCode. Style match(es) for Makeup, nails, hair, body, clothing, shoes, accessories (E.g. Derived from other characteristic matches to determine a matches for retailer product. Certain styles are a match to a retailer's product because of the retailer's product Physical Characteristics of ShapeCode and ColorCode).

Style Preferences. OccasionCode. Occasion match(es) for Makeup, nails, hair, body, clothing, shoes, accessories—Includes what to wear for what occasion: Business—Show what colors mean like blue means trusting, etc., Events: Wedding, Birthdays, Holidays, Themed Parties.

SurfaceMaterial Code. Physical Characteristics: Texture of Makeup, nails, hair, body, clothing, shoes, accessories.

Physical Characteristics: Surface of Makeup, nails, hair, body, clothing, shoes, accessories. Surface material preferences of body, face, facial features, hair and nails (fabrics and other materials).

Surface material match(es) of Makeup, nails, hair, body, clothing, shoes, accessories. Texture material match(es) of Makeup, nails, hair, body, clothing, shoes, accessories.

Texture material preferences. DimensionMeasurementCode. Physical Characteristics: Measurements of the Makeup, nails, hair, body, clothing, shoes, accessories. Physical Characteristics: Sizes of the Makeup, nails, hair, body, clothing, shoes, accessories. Physical Characteristics: 2D and 3D dimensions of Makeup, nails, hair, body, clothing, shoes, accessories.

ColorCode. Physical Characteristics Skin Coloring of Makeup, nails, hair, body, clothing, shoes, accessories. Color Match(es) for Makeup, nails, hair, body, clothing, shoes, accessories.

ShapeCode. Physical Characteristics: Shape of Makeup, nails, hair, body, clothing, shoes, accessories. Shape Match(es) for Makeup, nails, hair, body, clothing, shoes, accessories. Shape Preferences.

PatternCode. Physical Characteristics: Pattern of Makeup, nails, hair, body, clothing, shoes, accessories. Pattern match(es) location of Makeup, nails, hair, body, clothing, shoes, accessories. Pattern Preferences. AdditiveCode. Additive match(es) of Makeup, nails, hair, body, clothing, shoes, accessories. Additive Preferences. Utilizes the following:

Registering Consumers
Registered Consumers
Retailer's/Consumer's Preference on Privacy
Provider's/Consumer's Preference on Privacy
Similar Company Fields
Align Product(s) and Service(s)
Retailer/Service Provider Favorites
Stats of Company
Purchase Stats
PurchaseStatsCode
Entry of Consumer

Retailer will be able to save products or services on the retailer's wish list or cart on any device. Retailer will be able to send/print or generate a receipt of service/products to any device through video chat, email, instant messaging, text by sending images, descriptions of products, associated ProductCode, USearch, AIDC and/or unique product identifier or RSUTag to any device. Retailer will be able to send/print of retailer to any device through video chat, email, instant messaging, text by sending images, descriptions of retailer/products, associated ProductCode, AIDC and/or unique product identifier or RSUTag to any device.

Any device cross-references any device get the most accurate and up-to-date information of characteristics.

For a service provider, the system of the present disclosure can be adapted to also be stationary or mobile devices that input information and/or output information. Below shows how the products in the Make-Up, Nails, Hair, Body, Apparel/Clothing, Accessories and Shoes industry would be personalized to the service provider.

This will be a device for distribution center, service provider store, service provider company office, service provider warehouse, etc. of a company that services consumers in Make-Up, Nails, Hair, Body, Apparel/Clothing, Accessories and Shoes. Distribution center, service provider store, service provider company office, service provider warehouse, etc. of a company will be referred to as Service Provider/company type in this section.

The data derived from ServiceCode, ProductCode and UCode will keep the consumer, retailers and service providers consistent to provide the consumer with the best service and/or retail experience.

Any device will have the ability to scan, enter or transfer data from the AIDC and/or unique product identifier/RSUTag/ServiceCode associated with service provider.

For the industries of Makeup, nails, hair, body, clothing, shoes, accessories the characteristics that will create service personalization are StyleCode, OccasionCode, ColorCode, ShapeCode, DimensionMeasurementCode, SurfaceMaterialCode, PatternCode, WeightCode, HeightCode, AgeCode, GenderCode and AdditiveCode, while all are associated with UCode to be cross-referenced some will be associated with the ServiceCode to cross-referenced. These will be further narrowed down to “It's YOU”/Match for service(s) that Match Characteristics and Preferences of the consumer, Physical Characteristics of the service. These characteristics will be evaluated from retailer inputting data, social media sites, scale, consumer profiling, scanning or inputting AIDC and/or unique product identifier, dimension measurement, image generation, algorithms associating input(s) from service provider and algorithms from data derived from image generation. These characteristics can be categorized individually, grouped, cross-referenced for better analysis of the service.

This device will utilize product recognition and voice recognition and touchscreen technology or kinetic technology to make selections. Service recognition—will determine exact product.

E.g. StyleCode. Style match(es) for services associated with Makeup, nails, hair, body, clothing, shoes, accessories. Service Provider's sell Products and Services, so service providers can enter ProductCodes and ServiceCodes.

Service Provider Entry. Service provider will enter, scan or transfer all the data of the service provider's product(s) via RSUTag, ProductCode, ServiceCode, USpaceLookup or other AIDCs and/or unique product identifiers like a QRCode, UPC Codes, barcodes, etc./software mentioned into the device OR Service provider will enter the service provider's social media site to generate some of the information to be transferred to device. Service provider will be able to create a ServiceCode. Device will recognize location of company via GPS and search the internet via an algorithm to see if the service provider is a distribution center, service provider store, service provider company office, service provider warehouse, etc. and confirm with service provider. Service provider to confirm company name, website, company type and address via the device from the referenced location and information. If Service provider company is not determined via location, social media or RSUTag, ServiceCode or other AIDCs and/or unique product identifiers, App will ask Service provider to input location, company name, website, address and company type (distribution center, service provider store, service provider company office, service provider warehouse, etc.) Device will determine service/product style and/or occasion (if applicable) and product(s)/service(s) via the company name by searching the web for related words describing the style and/or occasion of the company. If device cannot determine style and/or occasion of company and services/products via company name or searching the company website or social media site, device will ask company to choose one or many selections from many different styles to decipher the company's overall style (rocker hair styles vs. prom hair styles) or occasion: Halloween, prom, wedding, etc. This input will generate tags if the consumer would like to search for a style or occasion via a device. Device will determine company services and/or products via the company name by searching the web for related words describing the services and/or products of the company type like Make-Up, Nails, Hair, Body, Apparel/Clothing, Accessories and Shoes and Make-Up—Like Makeover, Nails—like Pedicure and Manicure, Hair—Like Hair Cuts, Hair Coloring, Hair Styling, Brow wax, etc. Body—Tanning, Spa, Apparel/Clothing—Seamstress, personalized clothing, etc. This input will generate tags associated with the service provider ServiceCode, if the consumer would like to search for these services and/or products the consumer can search via the tags and the device will place the products and/or services in Sections, sub-sections and sub-subsections via cross-referencing the tags for consumer personalization on devices (referenced in Product Entry for products and referenced later in Service Entry for Services). If a service has previously been utilized on a consumer, then a USpaceLookup should be available for the Service Provider to look up this service. These USpaceLookups should be linked to the ServiceCode, which will be entered in during the Service Provider Entry.

Service Entering ProductCode. Device will ask for the company's z-axis measurement of Apparel/Clothing, Accessories and Shoes and an image of the Apparel/Clothing, Accessories and Shoes to do a dimension measurement to determine all physical characteristics of product and create 2D and/or 3D dimension images (Virtual Consumer Product(s)) of products including holographic images that would be saved to the ProductCode to determine a match of the product to the consumer via the consumer's UCode and link the product to the serviceCode (for location purposes, so the consumer can find the product at the service location). The device would have to gather the company's size chart for their products or other measurement data along with an image of the product to create a 2D and/or 3D image (Virtual Consumer Product(s)) of the product along with holographic images of product that would be saved to the ProductCode to determine a match with consumer's UCode. The device could also create an image generation via scanning in the product to determine all the physical characteristics of the product to create a 2D or 3D image (Virtual Consumer Product(s)) of the product along with holographic images that would be saved to the ProductCode to determine a match with consumer's UCode. Service provider will also be able to save Products to ProductCode via scanning the AIDC and/or unique product identifier or USearch. Device will determine product recognition via input from service provider or scan or camera or other visual imaging entity or AIDC and/or unique product identifier lookup. Device will ask service provider to select the type of Make-Up, Nails, Hair, Body, Apparel/Clothing, Accessories and Shoes if not determined via AIDC and/or unique product identifier or USearch or imaging recognition and uploads an image of the product the service provider would like to register.

Product Entry. Service provider will be able to determine the product's AgeCode, GenderCode, StyleCode, OccasionCode, ColorCode, ShapeCode, Dimension/MeasurementCode, SurfaceMaterialCode, PatternCode, WeightCode, HeightCode and AdditiveCode or utilize ProductCode to be stored into the ProductCode via a the product entry process above. This product entry process will create a ProductCode associated with username and password or AIDC and/or unique product identifier of the service provider's retailer.

Service provider/Retailer will be able to save products or services on the service provider's wish list or cart on any device. Service provider will be able to send/print or generate a receipt of service/products to any device through video chat, email, instant messaging, text by sending images, descriptions of products, associated ServiceCode, USearch, AIDC and/or unique product identifier or RSUTag to any device.

Service provider will be able to send/print information of service provider to any device through video chat, email, instant messaging, text by sending images, descriptions of service provider/products/services associated ServiceCode, AIDC and/or unique product identifier or RSUTag to any device.

Utilizes:
Registering Consumer
Registered Consumer
Service Provider Preference on Privacy
Provider's/Consumer's Preference on Privacy
Consumer Ranking of Service Provider
Similar Company Fields
Align Product(s) and Service(s)
Stats of a Company
Purchase Stats and PurchaseCode
Entry of Consumer

The following addresses UDesign and Decorating (Interior and/Exterior Design and Decorating). UInterior and/Exterior will image generate the consumer's home/office/store or any interior and/or exterior space that needs interior and/or exterior design/decorating attention into a 3D virtual home/office/store or any interior and/or exterior space that needs interior and/or exterior design/decorating attention and select the products that do not match as an overall perspective with checking matches by shape, color, height/width/depth and surface type, etc. The consumer would select from some categories the type of interior and/or exterior space the UInterior and/Exterior would be analyzing, such as aforementioned home, office, store, etc. The reason the UInterior and/Exterior asks for the consumer to enter the type of interior and/or exterior space is because homes/offices/shopping center's etc. should have certain colors/shapes/surface types, etc. for each room like a bedroom is different from a kitchen is different from a home office, whereas an office space should have colors for increasing productivity, whereas a retail industry should have colors that make consumers want to shop and buy, whereas a service industry like a spa should have colors/shapes/surface types to relax the consumer, etc. Then the UInterior and/Exterior would be able to Design/Decorate the interior and/or exterior by color. For instance, there should be 3 analogous colors in my living room if you are going with analogous colors in decorating or design, such as lime green, turquoise and sea green and my roommates added pink to our living room. Pink is on the opposite side of the color wheel. This does not work when the consumer has 3 analogous colors. Pink is a complimentary color, but isn't a match as the main colors are analogous. For shape, if the consumer had a lot of straight-line furniture with no detailed designs (contemporary pieces) and a few pieces with rounded corners (traditional pieces) then the rounded pieces would not be a match. UInterior and/Exterior could find out what the surface type is of the main items in an interior and/or exterior space. If the consumer has a group of wood pieces and a plastic chandelier, the chandelier's surface type would not fit with the other objects in the room. UInterior and/Exterior will be able to recognize blank walls and suggest items that would go well in the blank space via the colors, shapes, surface type and height/width/depth (measurements) of objects or surfaces in the room and on the walls. The UInterior and/Exterior would choose wall colors or other paint colors for objects in the room that fit by color analysis the colors of your furniture and such in the room. UInterior and/Exterior would be able to recommend organizers for a disorganized area in the consumer's home.

When consumers are moving they could utilize UInterior and/Exterior to decipher where to put certain objects in their new space. UInterior and/Exterior would go around their current home scanning the dining tables, paintings, couches, coffee tables, beds, etc. and then the Consumer would put UInterior and/Exterior into their new home where it would scan the dimensions of every room take in the colors of the current rooms distinguish where the kitchen, bathroom, bedroom, closets, hall ways by defining characteristics such as counters stairs, closet organizers, room sizes and such.

Overview: Interior/Exterior Designer/Decorator devices that will comprise of systems that have an interface for receiving an input reference style, color, shape, measurements, surface type of an object to determine the corresponding product matching, complementary or similar by style, color, shape, measurements, surface type (1) A scanner, camera, user input method, spectrophotometer to determine the style, color, shape, measurements, surface type, height and weight of an object(s). (2) Database of interior and exterior shapes, surface types, colors to match with styles of homes including Arts and Crafts, Asian, Contemporary, Cottage, Country, Eclectic, English Country, Mediterranean, Mid-Century Modern, Modern, Old World, Romantic, Southwestern, Traditional, Transitional, Tropical, Tuscan utilized to determine the style of the Bathrooms, Bedrooms, Dining Rooms, Entryways, Home Offices, Kid's Rooms, Kitchens, Living Rooms, Outdoors.

(3) Database of colors spanning all or most of the color spectrum (See FIGS. 14-16). The database will receive the color(s) from the home by the home getting scanned, photographed or analyzed by a spectrophotometer and determine the color match to determine the complementary color, analogous colors, monochromatic colors and/or triadic colors and be assigned a color code or select a color code that is the closest in relation to the actual color or will give the consumer the opportunity to choose colors that match to formulate the object(s) ideal colors that also are a match (4) The products are including the walls, rugs, artwork, light fixtures, window treatments, furniture, plants.

Again, the system will be stationary or mobile devices that input information and/or output information. Here, this approach is referred to as USpace. Below shows how the Interior/Exterior Design and Interior/Exterior Decorating Products and Services (Products and Services for these are in definitions) industry would be personalized to the consumer's space.

For the industries of Interior/Exterior Design and Interior/Exterior Decorating the characteristics that will create consumer's space personalization are StyleCode, OccasionCode, ColorCode, ShapeCode, DimensionMeasurementCode, SurfaceMaterialCode, PatternCode, AgeCode, Address Code and GenderCode. These will be further narrowed down to “It's YOU”/Match for product(s) and/or service(s) Match Characteristics, Physical Characteristics and Preference Characteristics of the consumer's space. These product/service matches will further be narrowed down by ConsumerSpaceStatCode, which will be derived by products/services shopped for or by scanning or creating an image generation of the home or office (including rooms inside of home or office and exterior yard of home or office). These characteristics will be evaluated from consumer's space inputting data, social media sites, consumer profiling of space, scanning or inputting AIDC and/or unique product identifier, dimension measurement, image generation, algorithms associating input(s) from consumer's space, consumer's space's calendar and algorithms from data derived from image generation. These characteristics can be categorized individually, grouped, cross-referenced for better analysis of the consumer's space.

In some instances, not all of these will be utilized to cross-reference that are all for a shell, decorating shell and/or design shell that are evaluated by a characteristic(s) in a space including a home/office in the home's/office's entirety, products/services within the home/office that are evaluated individually and/or entirety, and rooms within the home/office that are evaluated individually and/or entirety, except the Physical Characteristics: Age and Gender which are explained below.

Consumer Space Characteristics in Categories.

AgeCode. Physical Characteristic: Age (Consumer inputs birthday then device derives age/derived from social media site). Match Characteristics: Age (Products and Services that match the consumer's age).

GenderCode. Physical Characteristic: Gender (Inputted by consumer/derived from social media site/consumer profiling of space). Match Characteristic: Gender (Products and Services that match the consumer's gender).

AddressCode. Physical Characteristic: Address of home/office Space (Inputted by consumer/derived from social media site/current GPS location identified of the space).

StyleCode. Style preference(s): Style match(es) (Derived from other characteristic matches to determine a matches for consumer's space. Certain styles are a match to a consumer's space because of the consumer's space and consumer's Physical Characteristics)

OccasionCode. Occasion preference(s) (Inputted by consumer/derived from social media site/derived from consumer profiling of space of consumer's calendar of events, holidays, etc.). Occasion match(es) (Inputted by consumer/derived from social media site/derived from consumer profiling of space of consumer's calendar of events, holidays, etc.).

SurfaceMaterialCode. Physical Characteristics: Surface material; Physical Characteristics: Texture of materials; Surface material preferences; Texture of materials preferences; Surface material match(es) e; Texture of materials match(es).

DimensionMeasurementCode. Physical Characteristics: Measurements (window frames, doors, rooms, etc.); Physical Characteristics: Sizes (bedding: Twin, Queen, King and other sizes for spaces products and Services); Physical Characteristics: 2D and 3D dimensions.

ColorCode. Physical Characteristics: Coloring; Color Preference(s); Color Match(es); ShapeCode; Physical Characteristics: Shape; Shape Match(es); PatternCode; Pattern match(es); Pattern preference(s).

AgeCode. This will also narrow down what products/services are shown based on the consumer's age: (7-year-old is not going to want a room that looks like a 57 year olds room and a 50 year old is not going to want a home or office that looks like a 15 year olds home or office and a yard for a 50 year old is going to be different than a yard for a 1 year old) The products will only show what they would be interested in based on the consumer's age. (Social media site or inputted by consumer).

GenderCode. If they are evaluated to be a single male, then the device will include only sections, subsections and sub-subsections (these sections are just a categorization of the products/services) with only masculine products/services and if female vice versa. (Social media site or inputted by consumer or consumer profiling).

AddressCode. AddressCode will be able to narrow down the stylecode of the consumer's space as certain locations have certain styles of homes. They can also enter an addresscode for a different area, if the consumer likes those home styles. (Use GPS, consumer profiling or social media site to derive the consumer's space address, if it's the current location of the consumer. If not current location or on social media site, consumer will input the address. The address can merely be the city and state or the exact address.

StyleCode. Style preference: After the addresscode has narrowed the style code down to the top 10 of that city via a real estate social media site or the researching the web, the scanner will then identify which style(s) cross-referencing those styles with the current style by shape, surface materials and patterns to determine the style of the entirety of the home, individual rooms and products/services in the space. The consumer will also have the chance to look through various styles to possible chose a new style.

Style Match: Style(s) have certain characteristic(s) that make the style(s) unique. The style(s) products/services will be matched with the current style to help consumer chose products/services. Matches will be determined from consumer's space and consumer's space's Physical Characteristics.

OccasionCode. An occasion preference would be a preference on holidays to celebrate, events, birthdays, etc. based on the (consumer's space's calendar/social media site events for consumer's space/consumer input on space event).

Occasion matches would be the certain product(s)/service(s) that match the occasion. For instance you wouldn't decorate from x-mas in Easter decor, so x-mas decor would be a match. (Products will have certain occasioncodes to derive after cross-referencing all the characteristics of the space if the product/service is a match)

SurfaceMaterial Code (image generation including holograms to give consumer a reference/derived from consumer profiling of space. Inputted by consumer/image generation scanning then image recognition to determine by reflection of light from the product and type of product and coloring to determine the material. Derived by consumer profiling via the scan or inputted by consumer).

Physical Characteristics: Surface material(s) (Material types in Definitions section of Interior/Exterior Design and Interior/Exterior Decorating materials)) (Inputted by consumer/image generation scanning then image recognition to determine by reflection of light from the product and type of product and coloring to determine the material.)

Surface material preferences for a part or the entirety of the consumer's space such as fabrics, wood, metals, etc. Consumer could input the surface material preferences of even materials that are not in the consumer's space.

Surface material match(es) in products/services based on matching the materials of new products/services to current products/services in the space) If they prefer a material in a product/service that is not a match to the other materials, style of the space the layering technique would be utilized and recommend these materials in a different shape, etc. to alter the style, etc.

Textures of a space can be the same or a 2-3 different textures to spice things up. For instance, fabric made of thick yarn is going to have a different texture than silk. This works especially on medium sized patterns.

DimensionMeasurementCode. Physical Characteristics: This will include measurements even between products in the space as well to determine if a product is too close or far away to another product via checking the product's location and how it correlates with other products. This will include all the measurements of a product in a space to determine the height/width and depths of an product and correlate with other products in the space.

DimensionMeasurementCode evaluate the height, width and/or depth as a measurement to determine if the heights, width and/or depth goes well with the consumer's space. If a consumer's products/services go well with the consumer's space then the height will be a match. Also evaluates the heights of the current products to see if the current product's height work with the space. (Heights will be determined by scanning the products in the room or doing a dimensional measurement. It could also recognize the ProductCode or AIDC and/or unique product identifier from image recognition and determine the height from the AIDC and/or unique product identifier or image recognition via scanning and calculating the height. Scanning and determining height or using dimension measurement can determine the height of rooms and home.) (possibly use the focal length to determine measurements) Physical Size: To determine the size all the measurements would be put into a 3D or 2D model to recognize the size to the closest measurements of a product/service associated with size.

Devices will use image generation or dimension measurement to derive measurement, shape, size and form the related 2D or 3D image (listed under Dimensionmeasurementcode as Physical Characteristics: 2D and 3D dimensions of Interior/Exterior Design and Interior/Exterior Decorating).

Determine the scale size of various patterns to try not to use the same scale size pattern in a room. Example scale sizes are small, medium and large. Large should only be used once in a small room.

Determine the proportion compared to the size of the room of products in a room in relation to other products in a room. If device only has one camera, dimension measurement will be utilized or image generation will be utilized if more than one camera.

ColorCode. Physical Characteristics: receiving coloring data to determine the complementary, analogous, tertiary, etc. Color Preference(s) Device will have another screen for preferred or not preferred colors which will be linked to the consumer's space's ColorCode. The Device will allow them to either take an image generation of the consumer's space's preference: likes and dislikes of colors to save or the consumer's space can select the consumer's space's preference: likes and dislikes of colors from a color wheel. These colors can also be derived by scanning the space and consumer picking out favorite colors from scan E.g. If consumer had a rug or a painting as a focal point the consumer could select colors from the focal point as preferences or scan recognizing colors and choosing preference by counting times used in the space.

Color Match(es)—Colors will be determined to be a match for the consumer's space by analyzing the space to see if the color is analogous, complementary to the other colors in the space by analyzing the color, tone and undertone. Also the preference colors might not be analogous or complementary (contrast), so these colors would be removed from the area as these are not a match and possibly layered by dying fabrics.

Devices will check for varying intensities of the same colors chosen as matches and if no varying intensities will look for products/services that will give varying intensities of one color to the space.

As the image generation might obscure the colors in the space, the image generation will have the option to adjust the colors of the consumer's space. Consumer's space will be asked to upgrade to determine their colors that complement the consumer's space. The device would determine the consumer's space's primary color in the space's undertone complementary color, primary undertone analogous complementary colors, primary underhue complementary color, primary underhue analogous complementary colors from the consumer's space. This can also be done with the hue as well. The undertone, underhue and hue will be computed via an algorithm. The primary undertone complementary color will determine the color of interior/exterior product(s)/service(s) that would be complimentary to the space's undertone. The primary undertone analogous complementary colors will determine the colors near the primary undertone complimentary color would be their secondary complimentary undertone colors, which would determine the Consumer's space's tone colors for interior/exterior product(s)/service(s). The primary underhue complementary color will determine the coloring of interior/exterior product(s)/service(s) that would be complementary to their underhue. The primary underhue analogous complementary colors will determine the colors near the primary underhue complimentary color would be their secondary complimentary underhue colors, which would determine the Consumer's space's pure colors for interior/exterior product(s)/service(s). This will take the Consumer's space's hue colors and divide the hues, where the larger hue quantity will be divided over the smaller hue quantity to determine the primary underhue color. Hue (Pure Colors—on the outer part of the color wheel) (FIGS. 14 and 15) and Undertone Chart (Tones are added amount of gray to the hue)

ShapeCode. Physical Characteristics: Shape. Shape Match(es)—The matches of shape and line structure of services and products would be analyzed to match the shape and lines of the space. Shape Preferences—The consumer's space has preferences on liking or disliking shape will be stored under ShapeCode. Most consumers have shapes that goes along with the consumers' space home/office style. For instance, the shapes around my home space are straight lines and smooth curvy lines. There's also a theme with a lot of circular shapes as well in hardware for furniture, wood and iron furniture. This would recognize the common lines in the space and the common shapes in the space to determine the preferences.

PatternCode. Pattern match(es)—The match finds the location a pattern should be on the body based on the consumer's space's shape. Mixing prints for matches, try not to choose more than one of the same scale size or multiple patterns of the same scale. Place pattern fabrics in opposing directions like vertical, horizontal lines, zigzag, etc. Pattern Preference(s)—A consumer's space might have a preference in horizontal striped shirt, but the consumer's space's body is a strawberry, which is not a match.

Balance. Symmetrical and asymmetrical balance can be determined from the Dimensionmeasurementcode distance of products from one another and size of products along with shapecode. For example, a table in a room has two identical candlesticks placed on it, one on each end. This is symmetrical balance. Asymmetrical balance is achieved when two dissimilar objects are used to balance one another visually. Using the same table example one of the accessories might still be a candlestick, but the other might be an object such as a thin vase.

Rhythm. This is the visual repetition of a space. Similar elements need to be repeated throughout a space. This is accomplished by using the same space characteristics spread out within a space. For example, the shape of spherical lights hanging from the ceiling can be echoed in similarly shaped candle holders, sculptures or even round shapes painted on the walls.

Harmony. When scale of a space, visual interest with contrast, rhythm and balance a space is in harmony. This is what the space devices aim to achieve. This section will also allow Consumer's space to utilize their consumer's space's SpaceCode to find the consumer's space's StyleCode, OccasionCode, ColorCode, ShapeCode, DimensionMeasurementCode, SurfaceMaterialCode, PatternCode and AddressCode or space's associated consumer's AgeCode and GenderCode and then click on parts of the Consumer's space to determine the consumer's space's physical characteristic. For instance, if they clicked on ShapeCode and clicked on the consumer's space's furniture: couch and the consumer's space coach had straight lines and rounded off corner such as the couches below the ShapeCode would say:

Ex of ShapeCode Using Couch in photo. Physical Shape for couch: Lines: Straight (mostly horizontal) and rounded/curved. Shape Match(es) for couch: (Product(s)/Service Match(es) for couch) (Everything in this room is a product match to the coach because the lines are straight and the shapes are rounded/curved). Shape Preference(s) for couch: (Product(s)/Service Preference(s) for) Consumer likes zigzags and straight lines and don't like round/circular shapes. Examples of Characteristic Attributes that are cross-referenced by preferences, physical and matches would be removing or layering over the curved and circular shapes in the room. Possibly adding a zigzag fabric to the couch. Placing zigzag and straight line products in the room.

The device would tell consumer's space they are the attributes for Shape Match(es) for couch and Shape Preference(s) for body above. Then show on the consumer's space's image place each attribute of shape with products (unless it was a dislike then it won't be shown to consumer's space) with other attributes of other categories cross-referenced.

Characteristic attribute preferences will be analyzed by consumer's space profiling by finding patterns dealing with the consumer's space's different characteristic attributes previous purchases, wish lists, etc. in StyleCode, OccasionCode, ColorCode, ShapeCode, DimensionMeasurementCode, SurfaceMaterialCode, PatternCode, AgeCode and GenderCode.

Example of cross-referencing ColorCode and ShapeCode with previous ShapeCode: ShapeCode and ColorCode Physical Shape and Color of couch: Shape: Lines Straight (mostly horizontal) and curved and circles and rectangles, Color: Beige with Green Undertone (The undertone would have an algorithm calculation, so green is merely a guess)

Shape and Color Match(es) for couch: (Product(s)/Service Match(es) for couch) (Everything in this room is a product match to the coach because the lines are straight and curved and the shapes are round or rectangle, if green is the undertone red would be a complimentary color to green)

Shape Preference(s) for couch: (Product(s)/Service Preference(s) for) Consumer likes zigzags and straight lines and doesn't like round/circular shapes along with the color violet. The layering for coloring that would be added to the space because of the violet preference would be yellow zigzags fabric pillows to bring out the yellow in the green undertone couch with violet wall paint.

Any cross-referencing/groupling can be made from all or some of these StyleCode, OccasionCode, ColorCode, ShapeCode, DimensionMeasurementCode, SurfaceMaterialCode, PatternCode, AgeCode, GenderCode, AddressCode to make a consumer's space's SpaceCode.

Match means the product/service works with the consumer's space's physical characteristics “It Fits You” means it works with your preferences. If consumer's space has setup a user personal profile or an RSUTag or SpaceCode, the device will allow the consumer's space to utilize a feature called “Go Shopping” (mentioned previously). E.g. At the store, the consumer's space takes an image of a carpet the consumer prefers the carpet, so carpet would be recognized by image recognition or scans the carpet's associated AIDC and/or unique product identifier and the consumer's space will evaluate if the color and other characteristics match. For instance with color, the carpet could be a color match for the consumer's space i.e. it could be a match for one room and not another. If not recognized by AIDC and/or unique product identifier or image recognition consumer would input information relating to that it is carpet for flooring and device would find out if it is a match to the space, if not a match consumer could chose to layer a rug over the carpet to bring out the colors of the room. Device will also give the consumer colors that are a match and preference from the consumer's SpaceCode and have the ability to find products i.e. carpet nearby that works with the preference and match colors (and all other characteristics). The consumer will be able to evaluate based on the carpet being a wish list/purchase stat match based on price and available inventory online or instore. The consumer will also be able to show the carpet as a hologram or view the carpet on the consumer's device via zooming in and out of the carpet.

Consumer's space will also have the ability to “Go Shopping” on any device. The consumer's space will be able to search products by the type of product, product ranking, product Match/preferences of consumer's space to product and product price or product/service criteria or utilizing the data type that is in a ProductCode. The consumer's space will be able to select product/service criteria and compare product/service provider individual with other product/service provider individual with the attributes of the product/service criteria. This device will show only products that are a Match in characteristics. The consumer will select product/service for the interior/exterior design/decorating. Each will be evaluated by characteristics by being evaluated individually, cross-referenced and grouped as all or parts of the following:

Interior/Exterior Design ShapeCode
Interior/Exterior Design/Decorating StyleCode
Interior/Exterior Design/Decorating SurfaceMaterialCode
Interior/Exterior Design/Decorating OccasionCode
Interior/Exterior Design/Decorating PatternCode
Interior/Exterior Design/Decorating ColorCode
Interior/Exterior Design/Decorating Dimension/MeasurementCode
Interior/Exterior Design/Decorating AddressCode
Interior/Exterior Design/Decorating AgeCode
Interior/Exterior Design/Decorating GenderCode
Consumer's AgeCode
Consumer's GenderCode

If product, the consumer will select type of product narrowing it down by section, subsection, sub-subsection. If service, the consumer's space will select type of service narrowing it down by section, subsection and sub-subsection. The consumer's space will be able to search services/products by data in a ServiceCode/ProductCode. The consumer's space will be able to select compare the ranking of a service by ServiceCode data or ranking of product by ProductCode data. These products/services will deal with anything related to Interior/Exterior Design or Decorating Products/Services. The service provider/retailer will be able to lookup the service provider's previous services via USpaceLookup to see if “It Fits You”/Match the current consumer's space by utilizing the consumer's space's SpaceCode and using an algorithm to cross-reference. The Interior/Exterior Design/Decorating Products and/or Services examples are in definition of Interior/Exterior Product(s)/Service(s).

Utilizes these features:
Consumer's space Stats
ConsumerspaceStatsCode
Purchase Stats and PurchaseStatsCode
Tutorials
Align Product(s) and Service(s)
Retailer/Service Provider Favorites
Consumer's space Favorites
Trends
Retailer/Service Provider Restrictions
USpaceLookup
Go Shopping
Product Types
Service Types
Products/Services Purchased/Wish List
UOrganizer
USearch
USpaceLookup
Hologram Technology

Draping Technology (If the product moves at all the draping technology could show the movements of the product)

The characteristics gathered from consumer's space will create SpaceCode associated with username and password or other, database, software or AIDC and/or unique product identifier associated with a consumer space.

Online Store—This online store will be for consumer, retailers and service providers. Utilizes all features and abilities listed for UDesign and Decorating (Interior and/Exterior Design and Decorating). The products and services are that are utilized are in the Interior/Exterior Designer/Decorator definition. These will be organized in sections, subsections, sub-subsections. (Same as U Online Store, except with the above products/services and using the characteristics in the Interior/Exterior Designer/Decorator definition to cross-reference products/services to consumers' matches, preferences and physical characteristics of a space and these characteristics to cross-reference consumers' matches, preferences and physical characteristics of a space to products/services. These devices could also be taken to different rooms of the house and scan the individual rooms and then have the consumer put the rooms together to make the entire interior space from doing a scan/generated image from the ceiling with a horizontal scan/image generation from the x-axis and y-axis with one measurement from the room such as the height of the ceilings reference Dimensional measurement definition. It will have the ability to identify rooms by image recognition of the product types that are in the rooms. E.g. If there is a bed in a room, it's most likely a bedroom. The consumer will confirm for verification. Device will have the capability to put various products/services in a virtual space of the actual consumer space to view how the products/services look in a space. Device will be able to identify by USpaceLookup/USearch or previous USpacelookup/USearch. This will utilize “Hologram Technology” to put a hologram in the actual space to view the hologram to see how it functions and how it looks in the space and analyze match, preferences and physical characteristics.

Platform Scan of Products (See FIGS. 2A-C). This device has the ability to utilize one or many of the features, technology and abilities listed for UDesign and Decorating (Interior and/Exterior Design and Decorating). This device can be connected to all devices. This could scan individual products by putting products on the platform or space's by connecting the two pieces of the device an moving around the space to scan the actual space. This device uses characteristics to cross-reference products/services to consumers' matches, preferences and physical characteristics of a space and characteristics to cross-reference consumers' matches, preferences and physical characteristics of a space to products/services. This device would be able to scan the entire space without assistance from the consumer, except for going up and down stairs. The platform in the UCode description will not only be able to move 360 degrees, but will connect to a scanner in the center of the platform to be able to move in all different directions to scan rooms, hallways, etc. of a space to come up with the entire space's characteristics. It will have the ability to identify rooms by image recognition of the product types that are in the rooms. E.g. If there is a bed in a room, it's most likely a bedroom. The consumer will confirm for verification. Device will be able to identify by USpaceLookup or previous USpacelookup or USearch. Device will have the capability to put various products/services in a virtual space of the actual consumer space to view how the products/services look in a space. This will utilize “Hologram Technology” to put a hologram in the actual space to view the hologram to see how it functions and how it looks in the space and analyze match, preferences and physical characteristics.

Full-Body Product Scanner (See FIG. 3). This device has the ability to utilize one or many of the features, technology and abilities listed for UDesign and Decorating (Interior and/Exterior Design and Decorating). This device can be connected to all devices. This would be a device that will gather all physical characteristics of products via a full body scanner for products. The device would rotate around a product with a 360 degree rotation around the z-axis, while the product is being scanned the product will be the center of the z-axis in standard position and location that will create a 3D or 2D image generation. Retailer will have the ability to scan AIDC and/or unique product identifier of product, such as product code, purchasestatcode or any other AIDC and/or unique product identifier such as NFC with identification or any other ADIC (check definitions) that has stats, characteristics or purchase information for a space. The device will determine the product's characteristics and have the capability to transfer all physical characteristics, preferences and matches of these characteristics wire/wirelessly. On the output device the consumer/retailer/service provider will be able to rotate the 3D image or utilize dimensional movement/hologram technology to move the virtual product in the way the actual product moves and will be stored via retailer's ProductCode for purchases of products.

Consumer's space will be able to send/print or generate a receipt of products and/or services to any device through video chat, email, instant messaging, text by sending images, descriptions of products and/or services, associated ProductCode and/or ServiceCode, USearch, AIDC and/or unique product identifier or RSUTag, SpaceCode, USpaceLookup to any device.

Consumer of a space will be able to send/print of information and visuals of a consumer's space to any device through video chat, email, instant messaging, text by sending images, descriptions of consumer's space, associated SpaceCode, USearch, USpaceLookUp, AIDC and/or unique product identifier or RSUTag to any device.

Retailer. All devices mentioned in devices (definition) will have the capability of the following in this section. These devices will be stationary or mobile devices. These devices will be devices that input information and/or output information. Utilizes all/some features of devices listed in devices paragraphs. These devices utilize all technologies, information, data and/or features listed in USpace.

Below shows how the products in the Interior/Exterior Design and Decorating products would be personalized to the retailer. This will be a device for distribution center, retail store, company office, warehouse, etc. (retailer(s)/company type in this section), of a company that sells Interior/Exterior Design and Decorating products. Even uses an app, online store, full product scanner, platform or any other device in association with the product or retailer.

All the characteristic match(es)/physical characteristics will be referenced as Interior/Exterior Designer/Decorator characteristic match(es)/physical for a retailer product. An example with the match characteristic of StyleCode: StyleCode Style match(es) for Interior/Exterior Design and Interior/Exterior Decorating and Design (E.g. Derived from other characteristic matches to determine a matches for retailer product. Certain styles are a match to a retailer's product because of the retailer's product Physical Characteristics).

An example with the physical characteristic of DimensionMeasurementCode: DimensionMeasurementCode—Physical Characteristics: Measurements of the Interior/Exterior Design and Interior/Exterior Decorating and Design. Physical Characteristics: Sizes of the Interior/Exterior Design and Interior/Exterior Decorating. Physical Characteristics: 2D and 3D dimensions of Interior/Exterior Design and Interior/Exterior Decorating and Design. Device Utilizes features (Same as UCode except for SpaceCode and product's for Interior/Exterior Design and Interior/Exterior Decorating and relating to a retailer not a consumer and same as beauty products, but for interior/exterior products):

Product Entry
UFind
Registering Consumer's spaces
Registered Consumer's spaces
Retailer's/Consumer's space's Preference on Privacy
Similar Company Fields

A service provider/retailer company can have more than one field. Company fields include Furniture, Rugs, Plants, Lighting, Cushions, Water features, art, drapes/curtains, bedding, pillows, fire pits, dining ware, hardware, candleholders, vases, rocks, accessories and/or organizers. (Interior/Exterior Products and associated services). Examples of a similar field: Framing service and company that sells art and an advertiser service that advertises art and an attorney specializing in art, etc.

Align Product(s) and Service(s)
Retailer/Service Provider Favorites
Stats of Company
Purchase Stats
PurchaseStatsCode
Entry of Consumer's space
Products/Services Purchased/Wish List

Retailer will be able to save products or services on the retailer's wish list or cart on any device. Retailer will be able to send/print or generate a receipt of service/products to any device through video chat, email, instant messaging, text by sending images, descriptions of products, associated ProductCode, USearch, AIDC and/or unique product identifier or RSUTag to any device. Retailer will be able to send/print of retailer to any device through video chat, email, instant messaging, text by sending images, descriptions of retailer/products, associated ProductCode, AIDC and/or unique product identifier or RSUTag to any device.

Service Provider. All devices mentioned in devices (definition) will have the capability of the following in this section. These devices will be stationary or mobile devices. These devices will be devices that input information and/or output information. Utilizes all/some features of devices listed in devices paragraphs. These devices utilize all technologies, information, data and/or features listed in USpace. Below shows how the products in the Interior/Exterior Designer/Decorating services would be personalized to the service provider.

This will be a device for distribution center, service provider store, service provider company office, service provider warehouse, etc. (Service Provider/company type in this section), a company that services consumer's spaces via services for the Interior/Exterior Designer/Decorator areas.

Even uses an app, online store, full product scanner, platform or any other device in association with the product or retailer. All the characteristic match(es)/physical characteristics will be referenced as Interior/Exterior Designer/Decorator characteristic match(es)/physical for a service. An example with the match characteristic of StyleCode: StyleCode Style match(es) for Interior/Exterior Design and Interior/Exterior Decorating and Design (E.g. Derived from other characteristic matches to determine a match(es) for a service. Certain styles are a match to a service because of the services Physical Characteristics of a product utilized)

DimensionMeasurementCode Physical Characteristics: Measurements of the Interior/Exterior Design and Interior/Exterior Decorating and Design evaluated for services. Physical Characteristics Sizes of the Interior/Exterior Design and Interior/Exterior Decorating evaluated for services. Physical Characteristics: 2D and 3D dimensions of Interior/Exterior Design and Interior/Exterior Decorating and Design evaluated for services. Device—Service Provider's sell Products and Services, so service providers can enter ProductCodes and ServiceCodes. Device Utilizes features (Same as UCode except for SpaceCode and product's for Interior/Exterior Design and Interior/Exterior Decorating and relating to a retailer not a consumer and same as beauty products, but for interior/exterior products):

Service Provider Entry
Service Entering ProductCode
Product Entry

Same as Product Entry for Beauty products, except Service provider will be able to enter product code

Registering Consumer's spaces
Registered Consumer's spaces
Retailer's/Consumer's space's Preference on Privacy
Similar Company Fields

A service provider/retailer company can have more than one field. Company fields include Furniture, Rugs, Plants, Lighting, Cushions, Water features, art, drapes/curtains, bedding, pillows, fire pits, dining ware, hardware, candleholders, vases, rocks, accessories and/or organizers. Examples of a similar field: Framing service and company that sells art and an advertiser service that advertises art and an attorney specializing in art, etc.

Align Product(s) and Service(s)
Retailer/Service Provider Favorites
Stats of Company
Purchase Stats
Entry of Consumer's space
Products/Services Purchased/Wish List

Service provider will be able to save products or services on the service provider's wish list or cart on any device. Service Provider will be able to send/print or generate a receipt of service/products to any device through video chat, email, instant messaging, text by sending images, descriptions of products, associated ProductCode, USearch, AIDC and/or unique product identifier or RSUTag to any device.

Service Provider will be able to send/print of retailer to any device through video chat, email, instant messaging, text by sending images, descriptions of retailer/products, associated ProductCode, AIDC and/or unique product identifier or RSUTag to any device.

Thus, it will be apparent from the foregoing that, while particular forms of the invention have been illustrated and described, various modifications can be made without parting from the spirit and scope of the invention.

We claim:

1. A computerized system for personalization of consumer activity, comprising:
a computing device;
a database including personal information of a user; and
an image scanning and transmitting device;
wherein the image scanning and transmitting device communicates an image to the computing device;
wherein the computing device suggests products or services in real time based upon the image and personal information.

2. The system of claim 1, wherein the user is an individual.

3. The system of claim 1, wherein the computing device communicates with service providers or product procedures.

4. The system of claim 1, the image scanning and transmitting device is a camera.

5. The system of claim 1, the image scanning and transmitting device includes a rotating base.

6. The system of claim 1, the image scanning and transmitting device surrounds the user.

7. The system of claim 1, further comprising a hologram generating device.

8. The system of claim 7, wherein the hologram generating device generates a hologram in a space or onto the user to test commercial activity for the user.

9. The system of claim 1, wherein the system anticipates further commercial activity of the consumer and suggests commercial activity based upon time of year or physical condition of the consumer.

10. The system of claim 1, wherein the image scanning and transmitting device is configured to scan a space and the system suggests organizational products.

11. The system of claim 1, wherein the computing device locates a product or service geographically closest to the consumer based upon needs communicated or anticipated by the system.

12. The system of claim 1, further comprising a color analyzer, wherein the system suggests products based upon analyses conducted by the color analyzer.

13. The system of claim 1, wherein the system suggests services or products based upon physical attributes of the user.

14. The system of claim 1, wherein the image scanner and transmitting device captures data about a space, and the system suggests services or products based upon physical attributes of the user.

15. A captured method for personalized consumer activity, comprising:
entering personal information of a user into a computing device;
based upon the persona information entered, causing the computing device to suggest product or services for the user in real time.

16. The method of claim 15, further comprising providing the computing device with an image scanning and transmitting device and causing the image scan and transmitting device to capture and transmit an image.

17. The method of claim 15, further comprising configuring the system to suggest commercial activity based upon the image.

18. The method of claim 17, further comprising configuring the system to anticipate and communicate commercial activity at a future time based upon the personal information.

19. The system of claim 17, further comprising providing the system with holographic technology and employing the holographic technology to suggest commercial activity and test a service or product for the user.

20. The method of claim 1, further comprising finding products in real time based upon a geographical location of a user.
